(19) United States
(12) Patent Application Publication
(10) Pub. No.: US 2025/0334871 A1
(43) Pub. Date: Oct. 30, 2025

(54) PROJECTOR

(71) Applicant: SEIKO EPSON CORPORATION, Tokyo (JP)

(72) Inventors: Osamu NAKAJIMA, HARA-MURA (JP); Tomohiro TAKAGI, AZUMINO-SHI (JP); Masashi KATO, AZUMINO-SHI (JP); Kiyomi SATO, MATSUMOTO-SHI (JP)

(73) Assignee: SEIKO EPSON CORPORATION, Tokyo (JP)

(21) Appl. No.: 19/189,166

(22) Filed: Apr. 24, 2025

(30) Foreign Application Priority Data
Apr. 26, 2024 (JP) 2024-072336

(51) Int. Cl. G03B 21/20

(52) U.S. Cl. CPC G03B 21/208; G03B 21/2013; G03B 21/2066; G03B 21/2073

(57) ABSTRACT

In a projector, a first light in a first wavelength band and emitted from a first light source sequentially passes through a first light guide element and a first collimating element, and is incident on a photosynthetic element; a second light in a second wavelength band and emitted from a second light source sequentially passes through a second light guide element and a second collimating element, and is incident on the photosynthetic element; a third light in a third wavelength band and emitted from a third light source sequentially passes through a third light guide element and a third collimating element, and is incident on the photosynthetic element; and a first optical modulating element is provided with a reflection portion on a first surface side on which the first light is incident and in a region other than an opening portion of a display region.

The present application is based on, and claims priority from JP Application Serial Number 2024-072336, filed Apr. 26, 2024, the disclosure of which is hereby incorporated by reference herein in its entirety.

### BACKGROUND

### 1. Technical Field

The present disclosure relates to a projector.

### 2. Related Art

Hitherto, as an optical modulation apparatus that generates image light of each color of the three primary colors, there has been known a projector including three liquid crystal panels, in other words, a three-panel projector. For example, JP-A-2020-079820 discloses a projector including a light source device including a light source unit and a separating/synthesizing element, an illumination optical system, a color separating/synthesizing optical system, and a projection optical system. The light source unit emits exciton light of a phosphor. The separating/synthesizing element causes part of the light emitted from the light source unit to be incident on the phosphor, and causes the other part of the light emitted from the light source unit to be incident on a diffuser and be reflected at the diffuser. The illumination optical system illuminates the light emitted from the light source device. The color separating/synthesizing optical system executes color separation and color synthesis with respect to the light emitted from the illumination optical system. The projection optical system enlarges and projects the image light subjected to color synthesis onto an image display surface such as a screen.

In the three-panel projector disclosed in JP-A-2020-079820, white light is generated by the light source device, and then the color separating/synthesizing optical system arranged downstream of the light source device separates the white light into light of the respective colors. Thus, the projector disclosed in JP-A-2020-079820 is required to further include the color separating/synthesizing optical system in addition to the light source device. As a result, the number of components may be increased, and the projector may be increased in size. In other words, in the three-panel projector, it has been desired to take measures to reduce the number of components and prevent an increase in size. Further, improvement of in the utilization efficiency of the color light has been desired.

### SUMMARY

A projector according to an aspect of the present disclosure includes a first light source configured to emit a first light in a first wavelength band, a second light source configured to emit a second light in a second wavelength band different from the first wavelength band, a third light source configured to emit a third light in a third wavelength band different from the first wavelength band and the second wavelength band, a first light guide element including a first incidence end on which the first light emitted from the first light source is incident and a first emission end from which the first light is emitted, and being configured to equalize an in-plane illumination intensity of the first light, a second light guide element including a second incidence end on which the second light emitted from the second light source is incident and a second emission end from which the second light is emitted, and being configured to equalize an in-plane illumination intensity of the second light, a third light guide element including a third incidence end on which the third light emitted from the third light source is incident and a third emission end from which the third light is emitted, and being configured to equalize an in-plane illumination intensity of the third light, a first collimating element configured to collimate the first light emitted from the first light guide element, a second collimating element configured to collimate the second light emitted from the second light guide element, a third collimating element configured to collimate the third light emitted from the third light guide element, a first optical modulating element configured to modulate the first light emitted from the first collimating element, based on image information, a second optical modulating element configured to modulate the second light emitted from the second collimating element, based on image information, a third optical modulating element configured to modulate the third light emitted from the third collimating element, based on image information, a photosynthetic element configured to synthesize and emit the first light emitted from the first optical modulating element, the second light emitted from the second optical modulating element, and the third light emitted from the third optical modulating element, and a projection optical system configured to project the light emitted from the photosynthetic element. The first optical modulating element is provided with a reflection portion on a first surface side on which the first light is incident and in a region other than an opening portion of a display region.

In the projector according to the aspect of the present disclosure, the first optical modulating element includes a reflection portion on a first surface side on which the first light is incident and an outer side of a display region.

### BRIEF DESCRIPTION OF THE DRAWINGS

FIG. 1 is a schematic diagram illustrating a configuration of a projector of an embodiment.

FIG. 2 is a schematic diagram of a green light emission unit of the projector in FIG. 1.

FIG. 3 is a schematic diagram of the green light emission unit and an incidence-side polarizing element of the projector in FIG. 1.

FIG. 4 is a perspective exploded view of an optical modulating element on which green light of the projector in FIG. 1 is incident.

FIG. 5 is a cross-sectional view the incidence-side polarizing element and the optical modulating element on which the green light of the projector in FIG. 1 is incident.

FIG. 6 is a schematic diagram of the optical modulating element on which the green light of the projector in FIG. 1 is incident.

### DESCRIPTION OF EMBODIMENTS

Embodiments of the present disclosure are described below with reference to the drawings. In each of the drawings, the scale of the dimensions may be changed depending on the components in order to make each of the components easier to see.

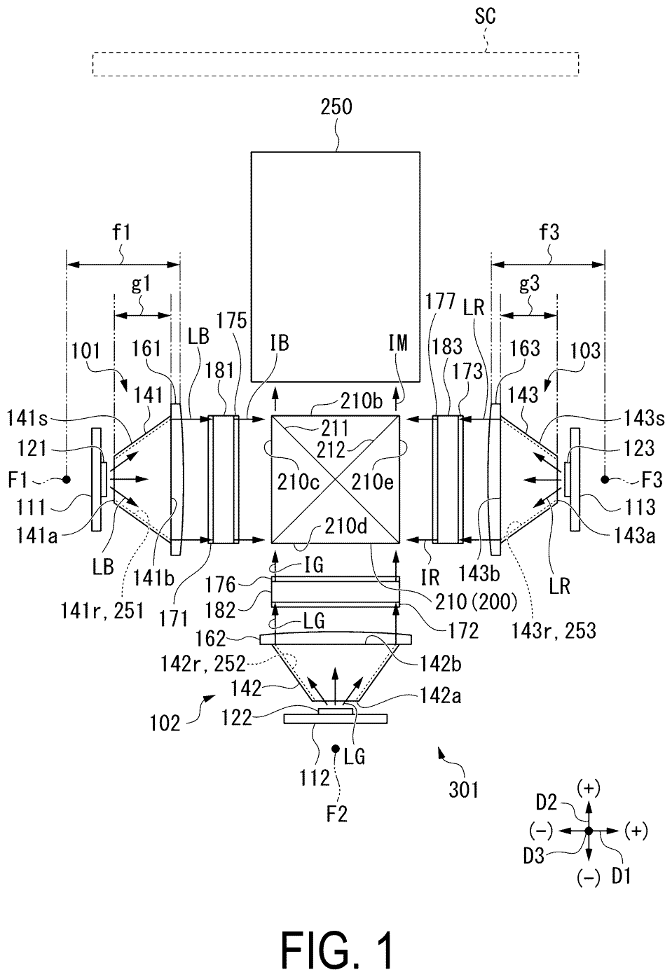

First, an embodiment of the present disclosure is described with reference to FIG. 1 to FIG. 6. FIG. 1 is a schematic diagram illustrating a configuration of a projector 301 of the embodiment of the present disclosure. The projector 301 is an image display apparatus including three liquid crystal panels as optical modulation devices, and is a so-called three-panel projector. As illustrated in FIG. 1, the projector 301 includes a blue light emission unit 101, a green light emission unit 102, a red light emission unit 103, incidence-side polarizing elements 171, 172, and 173, optical modulating elements 181, 182, and 183, emission-side polarizing elements 175, 176, and 177, a photosynthetic element 200, and a projection optical system 250.

The blue light emission unit 101 emits blue light LB. In the following description, it is assumed that a direction parallel to the optical axis of the blue light LB emitted from the blue light emission unit 101 is a D1 direction. It is assumed that one side in the D1 direction is a −D1 side and a side opposite to the −D1 side in the D1 direction is a +D1 side. It is assumed that, in a plane including the optical axis of the blue light LB, a direction orthogonal to the D1 direction is a D2 direction. It is assumed that one side in the D2 direction is a −D2 side and a side opposite to the −D2 side in the D2 direction is a +D2 side. It is assumed that a direction orthogonal to the D1 direction and the D2 direction is a D3 direction. The blue light LB emitted from the blue light emission unit 101 advances along the D1 direction to the +D1 side.

The blue light emission unit 101 includes a light source 121, a light guide element 141, and a collimating element 161. The light source 121 is supported on a base plate 111. The light source 121 is provided to the +D1-side plate surface of the base plate 111, among the plate surfaces parallel to the plane including the D2 direction and the D3 direction. A light emitting surface of the light source 121 is arranged substantially parallel to the plane including the D2 direction and the D3 direction, and is a surface that is opposite in the D1 direction to the surface of the light source 121 that contacts with the +D1-side plate surface of the base plate 111. The light source 121 corresponds to a second light source, and emits the blue light LB in the blue wavelength band in the visible wavelength band. The blue wavelength band corresponds to a second wavelength band. The blue light LB corresponds to second light. With the axis, which passes through the center of the light emitting surface of the light source 121 and is parallel to the D1 direction, as a center, the blue light LB is radiated from the light emitting surface of the light source 121 according to a predetermined radiation angle, and is emitted to the +D1 side. For example, the blue wavelength band is a wavelength band from 420 nm to 500 nm.

For example, the light source 121 is formed of a light emitting diode (LED) that emits the blue light LB. Note that the light source 121 may be formed of one LED, or may be formed of a plurality of LEDs as a whole. When the light source 121 is formed of the plurality of LEDs, the plurality of LEDs are arrayed in a region occupied by the light source 121 on the plane including the D2 direction and the D3 direction.

For example, the base plate 111 is formed of metal, and acts as a heat radiation member that receives heat from the light source 121 emitting the blue light LB and releases the heat to the external space.

The light guide element 141 is provided in the optical path of the blue light LB emitted from the light source 121, and is arranged on the +D1 side with respect to the light source 121 and arranged at a position overlapping with the light source 121 in the D2 direction and the D3 direction. The light guide element 141 corresponds to a second light guide element, and includes an incidence end 141a on the −D1 side in the D1 direction, an emission end 141b on the +D1 side, and a side surface 141s and a reflection surface 141r that extend in the D1 direction between the incidence end 141a and the emission end 141b. The incidence end 141a corresponds to a second incidence end, and expands parallel to the plane including the D2 direction and the D3 direction.

The shape of the incidence end 141a as viewed in the D1 direction is similar to the shape of the light emitting surface of the light source 121 as viewed in the same direction, and is a rectangular shape, for example. The size of the incidence end 141a in the plane including the D2 direction and the D3 direction may be equivalent to the size of the light emitting surface of the light source 121 in the plane including the D2 direction and the D3 direction, or may be moderately larger than the size of the light emitting surface of the light source 121 in the plane including the D2 direction and the D3 direction. The emission end 141b corresponds to a second emission end, expands parallel to the plane including the D2 direction and the D3 direction, and is larger than the incidence end 141a. The shape of the emission end 141b as viewed in the D1 direction is similar to the modulating surface of the optical modulating element 181 as viewed in the same direction, and is a rectangular shape, for example. The size of the emission end 141b in the plane including the D2 direction and the D3 direction is equivalent to the size of the modulating surface of the optical modulating element 181 in the plane including the D2 direction and the D3 direction. The side surface 141s and the reflection surface 141r connect the peripheral edge portion of the incidence end 141a and the peripheral edge portion of the emission end 141b to each other in the D1 direction.

The blue light LB emitted from the light source 121 is incident on the light guide element 141 through the incidence end 141a. In the light guide element 141, a region surrounded by the incidence end 141a, the emission end 141b, and the reflection surface 141r is a region to which the blue light LB propagates. The size of the region surrounded by the incidence end 141a, the emission end 141b, and the reflection surface 141r in the plane including the D2 direction and the D3 direction is increased as the region approaches the +D1 side from the −D1 side in the D1 direction. Further, the shape of the region surrounded by the incidence end 141a, the emission end 141b, and the reflection surface 141r in the plane including the D2 direction and the D3 direction is changed from the shape of the light emitting surface of the light source 121 as viewed in the D1 direction to the shape of the modulating surface of the optical modulating element 181, as the region approaches the +D1 side from the −D1 side.

The side surface 141s of the light guide element 141 and the reflection surface 141r, which is provided to the side surface 141s as described later, form a predetermined angle with respect to an imaginary line orthogonal to the incidence end 141a and the optical axis, and are away from the virtual line in the plane including the D2 direction and the D3 direction as moving from the −D1 side to the +D1 side. The blue light LB incident on the light guide element 141 propagates from the −D1 side to the +D1 side within the region surrounded by the incidence end 141a, the emission end 141b, and the reflection surface 141r.

When the shape of the modulating surface of the optical modulating element 181 as viewed along the D1 direction is a rectangle shape, the shape of the light emitting surface of the light source 121 as viewed along the D1 direction is a rectangle shape approximately similar to the modulating surface of the optical modulating element 181. In this case, a predetermined angle α formed by the side surface 141s and the reflection surface 141r, which include the short sides of the rectangle shape, with respect to the above-mentioned virtual line and optical axis, in other words, a taper angle may fall within a range from 7 degrees to 22 degrees. A predetermined angle β formed by the side surface 141s and the reflection surface 141r, which include the long sides of the rectangle shape, with respect to the above-mentioned virtual line and optical axis, in other words, a taper angle may fall within a range from 14 degrees to 36 degrees. The ranges which the angles α and β may fall within are confirmed through numerical simulations based on the configuration of the blue light emission unit 101 and ray tracing.

A part of the blue light LB incident on the light guide element 141 is not incident on the reflection surface 141r even once, and directly propagates from the incidence end 141a to the emission end 141b along a direction forming an angle with respect to the above-mentioned virtual line and optical axis, which is smaller than the predetermined angle. The remaining part of the blue light LB incident on the light guide element 141 forms an angle with respect to the above-mentioned virtual line and optical axis, which is an angle equal to or larger than the predetermined angle, is incident on the reflection surface 141r through the incidence end 141a once or more, is reflected at the reflection surface 141r, and then arrives at the emission end 141b. The path of the ray of the blue light LB in the region surrounded by the incidence end 141a, the emission end 141b, and the reflection surface 141r differs according to the incident angle on the incidence end 141a, and there are plurality of paths with different numbers of reflections at the reflection surface 141r. With this, the illumination intensity distribution of the blue light LB propagating in the region surrounded by the incidence end 141a, the emission end 141b, and the reflection surface 141r is equalized in the plane including the D2 direction and the D3 direction. In other words, the light guide element 141 equalizes the illumination intensity distribution of the incident blue light LB in the plane including the D2 direction and the D3 direction. The blue light LB with the equalized illumination intensity distribution is emitted from the emission end 141b to the +D1 side.

For example, the light guide element 141 is a reflector formed of a transparent material such as optical glass. The light guide element 141 has a frame-like body, and is formed as a hollow member. As viewed in the D1 direction, the end of the frame-like body of the light guide element 141 on the −D1 side has a shape and a size that are similar to the incidence end 141a and the light emitting surface of the light source 121, and is formed to have a rectangular frame-like shape, for example. The end of the frame-like body of the light guide element 141 on the +D1 side has a shape and a size that are similar to the emission end 141b and the modulating surface of the optical modulating element 181, and is formed to have a rectangular frame-like shape having a size different from the end on the −D1 side, for example.

For example, the light guide element 141 is formed of plate-like members formed of a transparent material. As described above, when the shapes of the incidence end 141a and the emission end 141b as viewed in the D1 direction are a rectangular shape, the light guide element 141 is formed of the four plate-like members each having a trapezoid shape. The lengths of the sides parallel to the D2 direction or the D3 direction on the −D1 side, which correspond to the upper bases of the four plate-like members, are set according to the sizes of the incidence end 141a and the light emitting surface of the light source 121 in the D2 direction or the D3 direction. The lengths of the sides parallel to the D2 direction or the D3 direction on the +D1 side, which correspond to the lower bases of the four plate-like members, are set according to the sizes of the emission end 141b and the modulating surface of the optical modulating element 181 in the D2 direction or the D3 direction. Among the four plate-like members, a side corresponding to a one leg of one plate-like member of the two plate-like members is coupled to a side corresponding to the other leg of the other plate-like member.

When the light guide element 141 is formed of plate-like members formed of transparent members as described above, the side surface 141s, in other words, the plate surface of the plate-like member, which faces the external space of the light guide element 141, acts as the reflection surface 141r. In the light guide element 141, a reflection film 251 formed of a dielectric multilayer film or the like is provided to the plate surface facing the internal space of the light guide element 141 among the plate members forming the reflector so as to improve a reflectance of the blue light LB incident on the light guide element 141 through the incidence end 141a in the vicinity of the side surface 141s. A part of the blue light LB incident on the internal space of the light guide element 141 through the incidence end 141a is reflected at the reflection film 251, and advances to the +D1 side.

The intensity of the blue light LB that is reflected at the reflection film 251 and is emitted from the reflection film 251 may depend on the incident angle of the blue light LB incident on the reflection film 251. When the reflection film 251 is formed of a dielectric multilayer film, incident angle dependence of the intensity of the blue light LB emitted from the reflection film 251 is changed due to parameters such as a refractive index of a plurality of films included in the dielectric multilayer film, a film thickness, and the number of films. As described above, for example, when the angle α falls within the range from 7 degrees to 22 degrees, and the angle β falls within the range from 14 degrees to 36 degrees, the reflection film 251 is designed, and the parameters of the dielectric multilayer film are determined as appropriate. With this, the incident angle of the blue light LB at which the intensity of the blue light LB emitted from the reflection surface 141r is the highest falls within the range from 60 degrees to 90 degrees. The relationship between the incident angle of the blue light LB on the reflection surface 141r and the reflection film 251 and the intensity of the blue light LB emitted from the reflection surface 141r and the reflection film 251 is obtained through the numerical simulations based on the configuration of the blue light emission unit 101 and ray tracing.

Note that, when the light guide element 141 is formed of plate-like members formed of transparent members, and the plate surface facing the external space of the light guide element 141 among the plate members acts as the reflection surface 141r, a part of the blue light LB incident on the internal space of the light guide element 141 through the incidence end 141a is incident on the plate-like member through the plate surface facing the internal space of the light guide element 141 among the plate-like members, is refracted, is reflected at the plate surface facing the external space of the light guide element 141, propagates the plate-like member again, is refracted at the plate surface facing the internal space of the light guide element 141, is emitted to the internal space, and advances to the +D1 side.

The collimating element 161 is provided in the optical path of the blue light LB emitted from the light guide element 141, and is arranged on the +D1 side with respect to the light guide element 141 and arranged at a position overlapping with the light guide element 141 in the D2 direction and the D3 direction. The collimating element 161 corresponds to a second collimating element, and collimates, along the D1 direction, the blue light LB emitted from the light guide element 141.

For example, the collimating element 161 is a plano-convex lens, and includes an incidence surface formed of a flat surface orthogonal to the D1 direction and an emission surface formed of a convex curved surface protruding to the emission side of the blue light LB. A focal point F1 of the plano-convex lens forming the collimating element 161 is at least on the −D1 side with respect to the collimating element 161, is on the side opposite to the +D1 side from which the blue light LB is emitted from the collimating element 161, and is on the −D1 side with respect to the light guide element 141. The incidence surface of the plano-convex lens of the collimating element 161 contacts with the emission end 141b of the light guide element 141. The collimating element 161 contacts with the emission end 141b. Consequently, the blue light LB emitted from the emission end 141b of the light guide element 141 is maximally captured by the collimating element 161, and the loss of the blue light LB can be suppressed. However, the collimating element 161 may be an optical lens that can collimate the incident blue light LB other than the plano-convex lens, and may be arranged at an appropriate interval from the light guide element 141 in the D1 direction.

A focal length f1 of the collimating element 161 is more than a length g1 of the light guide element 141 from the incidence end 141a to the emission end 141b in the D1 direction. For example, the focal length f1 of the collimating element 161 may be 1.1 times or more the length g1 of the light guide element 141, and may be 1.1 times or more the length g1 and 2.0 times or less the length g1. When the focal length f1 is set to fall within the above-mentioned range, the blue light LB emitted from the light source 121 is collimated efficiently, and the utilization efficiency of the blue light LB is improved. The range which the focal length f1 may fall within is confirmed through the numerical simulations based on the configuration of the blue light emission unit 101 and ray tracing.

The incidence-side polarizing element 171 is provided in the optical path of the blue light LB emitted from the collimating element 161, and is arranged on the +D1 side with respect to the collimating element 161 and arranged at a position overlapping with the collimating element 161 in the D2 direction and the D3 direction. For example, the incidence-side polarizing element 171 contacts with the optical modulating element 181 from the −D1 side, and may be arranged at an appropriate interval from the optical modulating element 181 in the D1 direction. The incidence-side polarizing element 171 corresponds to a second polarizing element, and emits predetermined polarized light of the blue light LB emitted from the collimating element 161, along the D1 direction to the +D1 side. The predetermined polarized light corresponds to a second polarized light component, and is S-polarized light, for example.

For example, the incidence-side polarizing element 171 is a reflection-type polarizing plate or an absorption-type polarizing plate that includes a plate surface parallel to the plane including the D2 direction and the D3 direction. Note that, when light returning to the upstream optical elements including the collimating element 161 or stray light is to be suppressed, an absorption-type polarizing plate may be adopted as the incidence-side polarizing element 171. The incidence-side polarizing element 171 transmits a part including the predetermined polarized light in the incident blue light LB to the +D1 side, and reflects or absorbs the other part of the blue light LB to the −D1 side.

Note that the blue light LB emitted from the light source 121 includes at least P-polarized light and S-polarized light, and is random polarized light, for example. As described above, the S-polarized light component in the blue light LB emitted from the light source 121 sequentially passes through the light guide element 141 and the collimating element 161, is transmitted through the incidence-side polarizing element 171, and is emitted to the +D1 side with respect to the incidence-side polarizing element 171. The P-polarized light component in the blue light LB sequentially passes through the light guide element 141 and the collimating element 161 similarly to the S-polarized light component, but is reflected or absorbed by the incidence surface of the incidence-side polarizing element 171, and is emitted to the +D1 side with respect to the incidence-side polarizing element 171.

The optical modulating element 181 is provided in the optical path of the blue light LB emitted from the incidence-side polarizing element 171, and is arranged on the +D1 side with respect to the incidence-side polarizing element 171 and arranged at a position overlapping with the incidence-side polarizing element 171 in the D2 direction and the D3 direction. The optical modulating element 181 corresponds to a second modulating element, and modulates the blue light LB emitted from the incidence-side polarizing element 171, based on image information transmitted from an external image formation apparatus (omitted in illustration) such as a computer coupled to the optical modulating element 181.

For example, the optical modulating element 181 is a transmissive-type liquid crystal panel. The liquid crystal panel forming the optical modulating element 181 includes a plurality of pixels (omitted in illustration). Each of the pixels includes a switching element. For example, the switching element is a polysilicon thin film transistor (TFT). An electrical signal corresponding to brightness of the blue light at the relative position of each of the pixels in the modulating surface of the optical modulating element 181 on an image to be projected by the projector 301 is supplied to the switching element of each of the pixels. Each of the pixels modulates a vibration direction of the blue light LB incident from the incidence-side polarizing element 171 by an operation of the switching element corresponding to the above-mentioned electrical signal, and generates blue image light IB. The image light IB corresponds to the second light. The optical modulating element 181 emits the image light IB generated by the liquid crystal panel, along the D1 direction to the +D1 side.

The emission-side polarizing element 175 is provided in the optical path of the image light IB emitted from the optical modulating element 181, and is arranged on the +D1 side with respect to the optical modulating element 181 and arranged at a position overlapping with the optical modulating element 181 in the D2 direction and the D3 direction. For example, the emission-side polarizing element 175 contacts with the optical modulating element 181 from the +D1 side, and may be arranged at an appropriate interval from the optical modulating element 181 in the D1 direction. The emission-side polarizing element 175 corresponds to a fifth polarizing element, and emits predetermined polarized light of the image light IB emitted from the optical modulating element 181, along the D1 direction to the +D1 side. The predetermined polarized light corresponds to a fifth polarized light component, and is P-polarized light, for example.

For example, the emission-side polarizing element 175 is a reflection-type polarizing plate or an absorption-type polarizing plate that includes a plate surface parallel to the plane including the D2 direction and the D3 direction. Note that, when light returning to the optical modulating element 181 or stray light is to be suppressed, an absorption-type polarizing plate may be adopted as the emission-side polarizing element 175. The emission-side polarizing element 175 transmits a part including the predetermined polarized light in the incident image light IB to the +D1 side, and reflects or absorbs the other part of the image light IB to the −D1 side.

The green light emission unit 102 is arranged on the +D1 side and the −D2 side with respect to the blue light emission unit 101, and is arranged in the region overlapping with the blue light emission unit 101 in the D3 direction. The green light emission unit 102 emits green light LG. The green light LG emitted from the green light emission unit 102 advances along the D2 direction to the +D2 side.

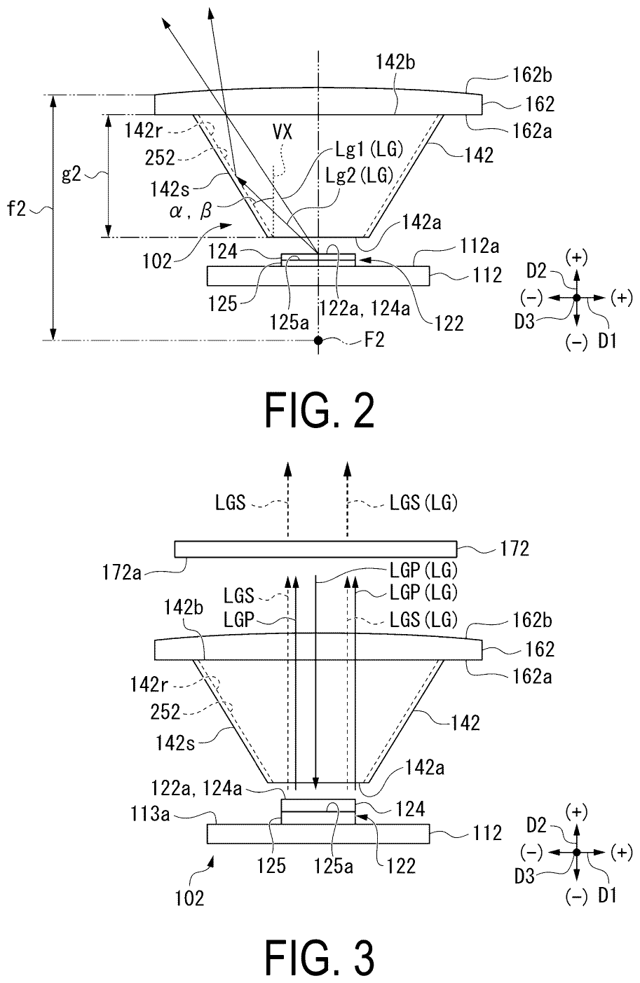

The green light emission unit 102 includes a light source 122, a light guide element 142, and a collimating element 162. FIG. 2 is a schematic diagram of the green light emission unit 102, and is a diagram as the green light emission unit 102 is viewed along the D3 direction. As illustrated in FIG. 2, the light source 122 is supported on a base plate 112. The light source 122 is provided to the +D2-side plate surface of the base plate 112, among the plate surfaces parallel to the plane including the D1 direction and the D3 direction. A light emitting surface 122a of the light source 122 is arranged substantially parallel to the plane including the D1 direction and the D3 direction, and is a surface that is opposite in the D2 direction to the surface of the light source 122 that contacts with the +D2-side plate surface of the base plate 112. The light source 122 corresponds to a first light source, and emits the green light LG in the green wavelength band in the visible wavelength band. The green wavelength band corresponds to a first wavelength band. The green light LG corresponds to first light. For example, the green wavelength band is a wavelength band from 500 nm to 600 nm.

For example, the light source 122 includes an LED that emits the green light LG. In the green light emission unit 102, the light source 122 is formed of an LED containing a phosphor, and includes an LED main body 125 formed of a semiconductor and a phosphor 124. As a result, the green wavelength and the intensity of the green light LG is optimized with respect to the blue wavelength and the intensity of the blue light LB emitted in the blue light emission unit 101 and the red wavelength and the intensity of the red light LR emitted in the red light emission unit 103.

The LED main body 125 is provided to the +D2-side plate surface of the base plate 112. The LED main body 125 corresponds to a light emitter of the light source 122, and is an LED that emits the blue light LB similarly to the light source 121, for example. The phosphor 124 is stacked on an emission surface 125a of the LED main body 125 on the +D2 side. The phosphor 124 is excited by excitation light being the light emitted from the LED main body 125, and emits the green light LG as fluorescence emitted from an emission surface 124a. The type and material of the LED main body 125 and the type and material of the phosphor 124 are selected as appropriate so that the phosphor 124 excited by the light emitted from the LED main body 125 emits the green light LG in the green wavelength band.

Note that, similarly to the light source 121, the LED main body 125 may be formed of one LED, or may be formed of a plurality of LEDs as a whole. When the LED main body 125 is formed of the plurality of LEDs, the plurality of LEDs are arrayed in a region occupied by the light source 122 on the plane including the D1 direction and the D3 direction.

For example, the base plate 112 is formed of metal, and acts as a heat radiation member that receives heat from the light source 122 emitting the green light LG and releases the heat to the external space.

The light guide element 142 is provided in the optical path of the green light LG emitted from the light source 122, and is arranged on the +D2 side with respect to the light source 122 and arranged at a position overlapping with the light source 122 in the D1 direction and the D3 direction. The light guide element 142 corresponds to a first light guide element, and includes an incidence end 142a on the −D2 side in the D2 direction, an emission end 142b on the +D2 side, and a side surface 142s and a reflection surface 142r that extend in the D2 direction between the incidence end 142a and the emission end 142b.

The incidence end 142a corresponds to a first incidence end, and expands parallel to the plane including the D1 direction and the D3 direction. The shape of the incidence end 142a as viewed in the D2 direction is similar to the shape of the light emitting surface 122a of the light source 122 as viewed in the same direction, and is a rectangular shape, for example. The size of the incidence end 142a in the plane including the D1 direction and the D3 direction may be equivalent to the size of the light emitting surface 122a of the light source 122 in the plane including the D1 direction and the D3 direction, or may be moderately larger than the size of the light emitting surface 122a in the plane including the D1 direction and the D3 direction.

The emission end 142b corresponds to a first emission end, expands parallel to the plane including the D1 direction and the D3 direction, and is larger than the incidence end 142a. The shape of the emission end 142b as viewed in the D2 direction is similar to the modulating surface of the optical modulating element 182 as viewed in the same direction, and is a rectangular shape, for example. The size of the emission end 142b in the plane including the D1 direction and the D3 direction is equivalent to the size of the modulating surface of the optical modulating element 182 in the plane including the D1 direction and the D3 direction. The side surface 142s and the reflection surface 142r connect the peripheral edge portion of the incidence end 142a and the peripheral edge portion of the emission end 142b to each other in the D2 direction.

The green light LG emitted from the light source 122 is incident on the light guide element 142 through the incidence end 142a. In the light guide element 142, a region surrounded by the incidence end 142a, the emission end 142b, and the reflection surface 142r is a region to which the green light LG propagates. The size of the region surrounded by the incidence end 142a, the emission end 142b, and the reflection surface 142r in the plane including the D1 direction and the D3 direction is increased as the region approaches the +D2 side from the −D2 side in the D2 direction. Further, the shape of the region surrounded by the incidence end 142a, the emission end 142b, and the reflection surface 142r in the plane including the D1 direction and the D3 direction is changed from the shape of the light emitting surface 122a of the light source 122 as viewed in the D2 direction to the shape of the modulating surface of the optical modulating element 182, as the region approaches the +D2 side from the −D2 side.

The side surface 142s of the light guide element 142 and the reflection surface 142r, which is provided to the side surface 142s as described later, form a predetermined angle with respect to an imaginary line VX orthogonal to the incidence end 142a and the optical axis, and are away from the virtual line in the plane including the D2 direction and the D3 direction as moving from the −D2 side to the +D2 side. The green light LG incident on the light guide element 142 propagates from the −D2 side to the +D2 side within the region surrounded by the incidence end 142a, the emission end 142b, and the reflection surface 142r.

When the shape of the modulating surface of the optical modulating element 182 as viewed along the D2 direction is a rectangle shape, the shape of the light emitting surface 122a of the light source 122 as viewed along the D2 direction is a rectangle shape having a relationship of approximate similarity with the modulating surface of the optical modulating element 182. In this case, a predetermined angle α formed by the side surface 142s and the reflection surface 142r, which include the short sides of the rectangle shape, with respect to the above-mentioned virtual line and optical axis may fall within a range from 7 degrees to 22 degrees. A predetermined angle β formed by the side surface 142s and the reflection surface 142r, which include the long sides of the rectangle shape, with respect to the above-mentioned virtual line and optical axis may fall within a range from 14 degrees to 36 degrees.

A ray Lg1 being a part of the green light LG incident on the light guide element 142 forms an angle with respect to the virtual line VX and the optical axis, which is smaller than the angle α or the angle β, is not incident on the reflection surface 142r even once, and directly propagates from the incidence end 142a to the emission end 142b. A ray Lg2 being the remaining part of the green light LG incident on the light guide element 142 forms an angle with respect to the virtual line VX and the optical axis, which is an angle equal to or larger than the angle a or the angle β, is incident on the reflection surface 142r through the incidence end 142a once, is reflected at the reflection surface 142r, and then arrives at the emission end 142b. A ray other than the ray Lg2 being the remaining part of the green light LG incident on the light guide element 142 is incident on the reflection surface 142r from the incidence end 142a twice or more, is repeatedly reflected at the reflection surface 142r, and then arrives at the emission end 142b.

The path of the ray of the green light LG in the internal space surrounded by the incidence end 142a, the emission end 142b, and the reflection surface 142r of the light guide element 142 differs according to the incident angle on the incidence end 142a, and there are plurality of paths with different numbers of reflections at the reflection surface 142r. With this, the illumination intensity distribution of the green light LG propagating in the internal space of the light guide element 142 is equalized in the plane including the D1 direction and the D3 direction. In other words, the light guide element 142 equalizes the illumination intensity distribution of the incident green light LG in the plane including the D1 direction and the D3 direction. The green light LG with the equalized illumination intensity distribution is emitted from the emission end 142b to the +D2 side.

For example, similarly to the light guide element 141, the light guide element 142 is a hollow reflector formed of plate-like members formed of a transparent material including glass such as optical glass. As viewed in the D2 direction, the end of the frame-like body of the reflector on the −D2 side has a shape and a size that are similar to the incidence end 142a and the light emitting surface 122a of the light source 122, and is formed to have a rectangular frame-like shape, for example. The end of the frame-like body of the reflector on the +D2 side has a shape and a size that are similar to the emission end 142b and the modulating surface of the optical modulating element 182, and is formed to have a rectangular frame-like shape having a size different from the end on the −D2 side, for example.

The reflector of the light guide element 142 is formed by coupling the sides corresponding to the legs of the four plate-like members each having a trapezoid shape, to each other. The lengths of the sides parallel to the D1 direction or the D3 direction on the −D2 side, which correspond to the upper bases of the four plate-like members, are set according to the sizes of the incidence end 142a and the light emitting surface 122a in the D1 direction or the D3 direction. The lengths of the sides parallel to the D1 direction or the D3 direction on the +D2 side, which correspond to the lower bases of the four plate-like members, are set according to the sizes of the emission end 142b and the modulating surface of the optical modulating element 182 in the D1 direction or the D3 direction.

In the reflector of the light guide element 142, a reflection film 252 such as a dielectric multilayer film is also provided to the plate surface opposite to the side surface 142s among the plate members forming the light guide element 142, in other words, the plate surface facing the internal space among the plate members so as to improve a reflectance of the green light LG incident on the light guide element 142 through the incidence end 142a in the vicinity of the side surface 142s. A ray being a part of the green light LG, which includes the ray Lg2 incident on the internal space of the reflector of the light guide element 142 through the incidence end 142a, is reflected at the reflection film 252, and advances to the +D1 side.

The intensity of the green light LG that is reflected at the reflection film 252 and is emitted from the reflection film 252 may depend on the incident angle of the green light LG incident on the reflection film 252. When the reflection film 252 is formed of a dielectric multilayer film, incident angle dependence of the intensity of the green light LG emitted from the reflection film 252 is changed due to parameters such as a refractive index of a plurality of films included in the dielectric multilayer film, a film thickness, and the number of films. As described above, for example, when the angle α falls within the range from 7 degrees to 22 degrees, and the angle β falls within the range from 14 degrees to 36 degrees, the reflection film 252 is designed, and the parameters of the dielectric multilayer film are determined as appropriate, With this, the incident angle of the green light LG at which the intensity of the green light LG emitted from the reflection surface 142r and the reflection film 252 is the highest falls within the range from 60 degrees to 90 degrees. The relationship between the incident angle of the green light LG on the reflection film 252 and the intensity of the green light LG emitted from the reflection film 252 is also obtained through numerical simulations based on the configuration of the green light emission unit 102 and ray tracing.

Note that, when the light guide element 142 is formed of plate-like members formed of transparent members, and the plate surface facing the external space of the light guide element 142 among the plate members acts as the reflection surface 142r, a part of the green light LG incident on the internal space of the light guide element 142 through the incidence end 142a is incident on the plate-like member through the plate surface facing the internal space of the light guide element 142 among the plate-like members, is refracted, is reflected at the plate surface facing the external space of the light guide element 142, propagates the plate-like member again, is refracted at the plate surface facing the internal space of the light guide element 142, is emitted to the internal space of the light guide element 142, and advances to the +D2 side.

The collimating element 162 is provided in the optical path of the green light LG emitted from the light guide element 142, and is arranged on the +D2 side with respect to the light guide element 142 and arranged at a position overlapping with the light guide element 142 in the D1 direction and the D3 direction. The collimating element 162 corresponds to a first collimating element, and collimates, along the D2 direction, the green light LG emitted from the light guide element 142.

For example, the collimating element 162 is a plano-convex lens, and includes an incidence surface 162a formed of a flat surface orthogonal to the D2 direction and an emission surface 162b formed of a convex curved surface protruding to the emission side of the blue light LB. A focal point F2 of the plano-convex lens forming the collimating element 162 is at least on the −D2 side with respect to the collimating element 162, is on the side opposite to the +D2 side from which the green light LG is emitted from the collimating element 162, and is on the −D2 side with respect to the light guide element 142. The incidence surface 162a of the collimating element 162 contacts with the emission end 142b of the light guide element 142. The collimating element 162 contacts with the emission end 142b. Consequently, the green light LG emitted from the emission end 142b of the light guide element 142 is maximally captured by the collimating element 162, and the loss of the green light LG can be suppressed. However, the collimating element 162 may be an optical lens that can collimate the incident green light LG other than the plano-convex lens, and may be arranged at an appropriate interval from the light guide element 142 in the D2 direction.

A focal length f2 of the collimating element 162 is more than the length g2 of the light guide element 142 from the incidence end 142a to the emission end 142b in the D2 direction. For example, the focal length f2 of the collimating element 162 may be 1.1 times or more the length g2 of the light guide element 142, and may be 1.1 times or more the length g2 and 2.0 times or less the length g2. When the focal length f2 is set to fall within the above-mentioned range, the green light LG emitted from the light source 122 is collimated efficiently, and the utilization efficiency of the green light LG is improved. The range which the focal length f2 may fall within is confirmed through the numerical simulations based on the configuration of the green light emission unit 102 and ray tracing.

FIG. 3 is a schematic diagram of the green light emission unit 102 and the incidence-side polarizing element 172, and is a diagram as the green light emission unit 102 and the incidence-side polarizing element 172 are viewed along the D3 direction. As illustrated in FIG. 3, the incidence-side polarizing element 172 is provided in the optical path of the green light LG emitted from the collimating element 162, and is arranged on the +D2 side with respect to the collimating element 162 and arranged at a position overlapping with the collimating element 162 in the D1 direction and the D3 direction. For example, the incidence-side polarizing element 172 may contact with the optical modulating element 182 from the +D2 side as illustrated in FIG. 1, or may be arranged at an appropriate interval from the optical modulating element 182 in the D2 direction as illustrated in FIG. 3.

The incidence-side polarizing element 172 corresponds to a first polarizing element, and emits predetermined polarized light of the green light LG emitted from the collimating element 162, along the D2 direction to the +D2 side. The predetermined polarized light corresponds to a first polarized light component, and is S-polarized light, for example. For example, the incidence-side polarizing element 172 is a reflection-type polarizing plate or an absorption-type polarizing plate that includes a plate surface parallel to the plane including the D1 direction and the D3 direction. The incidence-side polarizing element 172 transmits a part including the predetermined polarized light in the incident green light LG to the +D2 side, and reflects the other part of the green light LG to the −D2 side.

As illustrated in detail in FIG. 3, the green light LG emitted from the light source 122 is random polarized light including at least P-polarized light and S-polarized light. Green light LGS being a S-polarized light component in the green light LG emitted from the light source 122 and green light LGP being a P-polarized light component in the green light LG are totally reflected at the light guide element 142 according to the emission angle from the light source 122 as described above, are guided as the green light LG to the +D2 side, are subjected to equalization of the illumination intensity distribution in the plane including the D1 direction and the D3 direction by the light guide element 142, and are further emitted to the +D2 side with respect to the light guide element 142. The green light LGS and the green light LGP pass through the collimating element 162, and are collimated by the collimating element 162. The green light LGS and the green light LGP that are collimated are incident on the incidence-side polarizing element 172 from the −D2 side. The green light LGS is transmitted through the incidence-side polarizing element 172, and is emitted to the +D2 side with respect to the incidence-side polarizing element 172. The green light LGP is absorbed or reflected at an incidence surface 172a of the incidence-side polarizing element 172, and is emitted to the −D2 side with respect to the incidence-side polarizing element 172.

When the green light LGP is reflected at the incidence-side polarizing element 172 to the −D2 side, the green light LGP sequentially passes through the collimating element 162 and the light guide element 142, advances along the D2 direction to the −D2 side, is condensed in the plane including the D1 direction and the D3 direction, and is incident on the phosphor 124 of the light source 122 from the +D2 side. The phosphor 124 is re-excited by the green light LGP that is emitted from the incidence-side polarizing element 172 to the −D2 side, and emits the green light LG including the green light LGS and the green light LGP again from the emission surface 124a to the +D2 side. The incidence-side polarizing element 172 is formed of a reflection-type polarizing plate. With this, the polarized light of the green light LG that is not transmitted through the incidence-side polarizing element 172 is re-incident on the phosphor 124 of the light source 122, and contributes to excitation and light emission of the phosphor 124. As a result, the utilization efficiency of the green light LG in the green light emission unit 102 and the projector 301 is improved.

As illustrated in FIG. 1, the optical modulating element 182 is provided in the optical path of the green light LG emitted from the incidence-side polarizing element 172, and is arranged on the +D2 side with respect to the incidence-side polarizing element 172 and arranged at a position overlapping with the incidence-side polarizing element 172 in the D1 direction and the D3 direction. The optical modulating element 182 corresponds to a first modulating element, and modulates the green light LG emitted from the incidence-side polarizing element 172, based on image information transmitted from an external image formation apparatus (omitted in illustration) such as a computer coupled to the optical modulating element 182.

For example, the optical modulating element 182 is a transmissive-type liquid crystal panel. The liquid crystal panel forming the optical modulating element 182 includes a plurality of pixels (omitted in illustration). Each of the pixels includes a switching element. For example, the switching element is a TFT. An electrical signal corresponding to brightness of the green light at the relative position of each of the pixels in the modulating surface of the optical modulating element 182 on an image to be projected by the projector 301 is supplied to the switching element of each of the pixels. Each of the pixels modulates a vibration direction of the green light LG incident from the incidence-side polarizing element 172 by an operation of the switching element corresponding to the above-mentioned electrical signal, and generates green image light IG. The image light IG corresponds to the first light. The optical modulating element 182 emits the image light IG generated by the liquid crystal panel, along the D2 direction to the +D2 side.

The emission-side polarizing element 176 is provided in the optical path of the image light IG emitted from the optical modulating element 182, and is arranged on the +D2 side with respect to the optical modulating element 182 and arranged at a position overlapping with the optical modulating element 182 in the D1 direction and the D3 direction. For example, the emission-side polarizing element 176 contacts with the optical modulating element 182 from the +D2 side, and may be arranged at an appropriate interval from the optical modulating element 182 in the D2 direction. The emission-side polarizing element 176 corresponds to a fourth polarizing element, and emits predetermined polarized light of the image light IG emitted from the optical modulating element 182, along the D2 direction to the +D2 side. The predetermined polarized light corresponds to a fourth polarized light component, and is P-polarized light, for example. For example, the emission-side polarizing element 176 is a reflection-type polarizing plate or an absorption-type polarizing plate that includes a plate surface parallel to the plane including the D1 direction and the D3 direction. Note that, when light returning to the optical modulating element 182 or stray light is to be suppressed, an absorption-type polarizing plate may be adopted as the emission-side polarizing element 176. The emission-side polarizing element 176 transmits a part including the predetermined polarized light in the incident image light IG to the +D2 side, and reflects or absorbs the other part of the image light IG to the −D2 side.

As illustrated in FIG. 1, the red light emission unit 103 is arranged on the +D1 side with respect to the green light emission unit 102, and is arranged in the region overlapping with the blue light emission unit 101 in the D2 direction and the D3 direction. The red light emission unit 103 emits the red light LR. The red light LR emitted from the red light emission unit 103 advances along the D1 direction to the −D1 side.

The red light emission unit 103 includes a light source 123, a light guide element 143, and a collimating element 163. The light source 123 is supported on a base plate 113. The light source 123 is provided to the −D1-side plate surface of the base plate 113, among the plate surfaces parallel to the plane including the D2 direction and the D3 direction. A light emitting surface of the light source 123 is arranged substantially parallel to the plane including the D2 direction and the D3 direction, and is a surface that is opposite in the D1 direction to the surface of the light source 123 that contacts with the-D1-side plate surface of the base plate 113. The light source 123 corresponds to a third light source, and emits the red light LR in the red wavelength band in the visible wavelength band. The red wavelength band corresponds to a third wavelength band. The red light LR corresponds to third light. With the axis, which passes through the center of the light emitting surface of the light source 123 and is parallel to the D1 direction, as a center, the red light LR is radiated from the light emitting surface of the light source 123 according to a predetermined radiation angle, and is emitted to the −D1 side. For example, the red wavelength band is a wavelength band from 610 nm to 700 nm.

For example, the light source 123 is formed of an LED that emits the red light LR. Note that the light source 123 may be formed of one LED, or may be formed of a plurality of LEDs as a whole. When the light source 123 is formed of the plurality of LEDs, the plurality of LEDs are arrayed in a region occupied by the light source 123 on the plane including the D2 direction and the D3 direction.

For example, the base plate 113 is formed of metal, and acts as a heat radiation member that receives heat from the light source 123 emitting the red light LR and releases the heat to the external space.

The light guide element 143 is provided in the optical path of the red light LR emitted from the light source 123, and is arranged on the −D1 side with respect to the light source 123 and arranged at a position overlapping with the light source 123 in the D2 direction and the D3 direction. The light guide element 143 corresponds to a third light guide element, and includes an incidence end 143a on the +D1 side in the D1 direction, an emission end 143b on the −D1 side, and a side surface 143s and a reflection surface 143r that extend in the D1 direction between the incidence end 143a and the emission end 143b. The incidence end 143a corresponds to a third incidence end, and expands parallel to the plane including the D2 direction and the D3 direction.

The shape of the incidence end 143a as viewed in the D1 direction is similar to the shape of the light emitting surface of the light source 123 as viewed in the same direction, and is a rectangular shape, for example. The size of the incidence end 143a in the plane including the D2 direction and the D3 direction may be equivalent to the size of the light emitting surface of the light source 123 in the plane including the D3 direction and the D3 direction, or may be moderately larger than the size of the light emitting surface of the light source 123 in the plane including the D2 direction and the D3 direction. The emission end 143b corresponds to a third emission end, expands parallel to the plane including the D2 direction and the D3 direction, and is larger than the incidence end 143a. The shape of the emission end 143b as viewed in the D1 direction is similar to the modulating surface of the optical modulating element 183 as viewed in the same direction, and is a rectangular shape, for example. The size of the emission end 143b in the plane including the D2 direction and the D3 direction is equivalent to the size of the modulating surface of the optical modulating element 183 in the plane including the D2 direction and the D3 direction. The side surface 143s and the reflection surface 143r connect the peripheral edge portion of the incidence end 143a and the peripheral edge portion of the emission end 143b to each other in the D1 direction.

The red light LR emitted from the light source 123 is incident on the light guide element 143 through the incidence end 143a. In the light guide element 143, a region surrounded by the incidence end 143a, the emission end 143b, and the reflection surface 143r is a region to which the red light LR propagates. The size of the region surrounded by the incidence end 143a, the emission end 143b, and the reflection surface 143r in the plane including the D2 direction and the D3 direction is increased as the region approaches the −D1 side from the +D1 side in the D1 direction. Further, the shape of the region surrounded by the incidence end 143a, the emission end 143b, and the reflection surface 143r in the plane including the D2 direction and the D3 direction is changed from the shape of the light emitting surface of the light source 123 as viewed in the D1 direction to the shape of the modulating surface of the optical modulating element 183, as the region approaches the −D1 side from the +D1 side.

The side surface 143s of the light guide element 143 and the reflection surface 143r, which is provided to the side surface 143s as described later, form a predetermined angle with respect to an imaginary line orthogonal to the incidence end 143a and the optical axis, and are away from the virtual line in the plane including the D2 direction and the D3 direction as moving from the +D1 side to the −D1 side. The red light LR incident on the light guide element 143 propagates from the +D1 side to the −D1 side within the region surrounded by the incidence end 143a, the emission end 143b, and the reflection surface 143r.

When the shape of the modulating surface of the optical modulating element 183 as viewed along the D1 direction is a rectangle shape, the shape of the light emitting surface of the light source 123 as viewed along the D1 direction is a rectangle shape having a relationship of approximate similarity with the modulating surface of the optical modulating element 183. In this case, a predetermined angle α formed by the side surface 143s and the reflection surface 143r, which include the short sides of the rectangle shape, with respect to the above-mentioned virtual line and optical axis, in other words, a taper angle may fall within a range from 7 degrees to 22 degrees. A predetermined angle β formed by the side surface 143s and the reflection surface 143r, which include the long sides of the rectangle shape, with respect to the above-mentioned virtual line and optical axis, in other words, a taper angle may fall within a range from 14 degrees to 36 degrees. The ranges which the angles α and β may fall within are confirmed through numerical simulations based on the configuration of the red light emission unit 103 and ray tracing.

A part of the red light LR incident on the light guide element 143 is not incident on the reflection surface 143r even once, and directly propagates from the incidence end 143a to the emission end 143b along a direction forming an angle with respect to the virtual line and the optical axis, which is smaller than the predetermined angle. The remaining part of the red light LR incident on the light guide element 143 forms an angle with respect to the virtual line and the optical axis, which is an angle equal to or larger than the predetermined angle, is incident on the reflection surface 143r through the incidence end 143a once or more, is reflected at the reflection surface 143r, and then arrives at the emission end 143b. The path of the ray of the red light LR in the region surrounded by the incidence end 143a, the emission end 143b, and the reflection surface 143r differs according to the incident angle on the incidence end 143a, and there are plurality of paths with different numbers of reflections at the reflection surface 143r. With this, the illumination intensity distribution of the red light LR propagating in the region surrounded by the incidence end 143a, the emission end 143b, and the reflection surface 143r is equalized in the plane including the D2 direction and the D3 direction. In other words, the light guide element 143 equalizes the illumination intensity distribution of the incident red light LR in the plane including the D2 direction and the D3 direction. The red light LR with the equalized illumination intensity distribution is emitted from the emission end 143b to the −D1 side.

For example, similarly to the light guide elements 141 and 142, the light guide element 143 is a hollow reflector formed of plate-like members formed of a transparent material including glass such as optical glass. As viewed in the D1 direction, the end of the frame-like body of the light guide element 143 on the +D1 side has a shape and a size that are similar to the incidence end 143a and the light emitting surface of the light source 123, and is formed to have a rectangular frame-like shape, for example. The end of the frame-like body of the light guide element 143 on the −D1 side has a shape and a size that are similar to the emission end 143b and the modulating surface of the optical modulating element 183, and is formed to have a rectangular frame-like shape having a size different from the end on the +D1 side, for example.

The light guide element 143 is formed by coupling the sides corresponding to the legs of the four plate-like members each having a trapezoid shape, to each other. The lengths of the sides parallel to the D2 direction or the D3 direction on the +D1 side, which correspond to the upper bases of the four plate-like members, are set according to the sizes of the incidence end 143a and the light emitting surface of the light source 123 in the D2 direction or the D3 direction. The lengths of the sides parallel to the D2 direction or the D3 direction on the −D1 side, which correspond to the lower bases of the four plate-like members, are set according to the sizes of the emission end 143b and the modulating surface of the optical modulating element 183 in the D2 direction or the D3 direction.

In the light guide element 143, a reflection film 253 such as a dielectric multilayer film is also provided to the plate surface opposite to the side surface 143s among the plate members forming the light guide element 143, in other words, the plate surface facing the internal space of the light guide element 143 among the plate members so as to improve a reflectance of the red light LR incident on the light guide element 143 through the incidence end 143a in the vicinity of the side surface 143s. A part of the red light LR incident on the internal space of the light guide element 143 through the incidence end 143a is reflected at the reflection film 253, and advances to the −D1 side.

The intensity of the red light LR that is reflected at the reflection film 253 and is emitted from the reflection film 253 may depend on the incident angle of the red light LR incident on the reflection film 253. When the reflection film 253 is formed of a dielectric multilayer film, incident angle dependence of the intensity of the red light LR emitted from the reflection film 253 is changed due to parameters such as a refractive index of a plurality of films included in the dielectric multilayer film, a film thickness, and the number of films. As described above, for example, when the angle α falls within the range from 7 degrees to 22 degrees, and the angle β falls within the range from 14 degrees to 36 degrees, the reflection film 253 is designed, and the parameters of the dielectric multilayer film are determined as appropriate, With this, the incident angle of the red light LR at which the intensity of the red light LR emitted from the reflection surface 143r and the reflection film 253 is the highest falls within the range from 60 degrees to 90 degrees. The relationship between the incident angle of the red light LR on the reflection film 253 and the intensity of the red light LR emitted from the reflection film 253 is also obtained through the numerical simulations based on the configuration of the red light emission unit 103 and ray tracing.

Note that, when the light guide element 143 is formed of plate-like members formed of transparent members, and the plate surface facing the external space of the light guide element 143 among the plate members acts as the reflection surface 143r, a part of the red light LR incident on the internal space of the light guide element 143 through the incidence end 143a is incident on the plate-like member through the plate surface facing the internal space of the light guide element 143 among the plate-like members, is refracted, is reflected at the plate surface facing the external space of the light guide element 143, propagates the plate-like member again, is refracted at the plate surface facing the internal space of the light guide element 143, is emitted to the internal space of the light guide element 143, and advances to the −D1 side.

The collimating element 163 is provided in the optical path of the red light LR emitted from the light guide element 143, and is arranged on the −D1 side with respect to the light guide element 143 and arranged at a position overlapping with the light guide element 143 in the D2 direction and the D3 direction. The collimating element 163 corresponds to a third collimating element, and collimates, along the D1 direction, the red light LR emitted from the light guide element 143.

For example, the collimating element 163 is a plano-convex lens, and includes an incidence surface formed of a flat surface orthogonal to the D1 direction and an emission surface formed of a convex curved surface protruding to the emission side of the red light LR. A focal point F3 of the plano-convex lens forming the collimating element 163 is at least on the +D1 side with respect to the collimating element 163, is on the side opposite to the −D1 side from which the red light LR is emitted from the collimating element 163, and is on the +D1 side with respect to the light guide element 143. The incidence surface of the collimating element 163 contacts with the emission end 143b of the light guide element 143. The collimating element 163 contacts with the emission end 143b. Consequently, the red light LR emitted from the emission end 143b of the light guide element 143 is maximally captured by the collimating element 163, and the loss of the red light LR can be suppressed. However, the collimating element 163 may be an optical lens that can collimate the incident red light LR other than the plano-convex lens, and may be arranged at an appropriate interval from the light guide element 143 in the D1 direction.

A focal length f3 of the collimating element 163 is more than the length g3 of the light guide element 143 from the incidence end 143a to the emission end 143b in the D1 direction. For example, the focal length f3 of the collimating element 163 may be 1.1 times or more the length g3 of the light guide element 143, and may be 1.1 times or more the length g3 and 2.0 times or less the length g3. When the focal length f3 is set to fall within the above-mentioned range, the red light LR emitted from the light source 123 is collimated efficiently, and the utilization efficiency of the red light LR is improved. The range which the focal length f3 may fall within is confirmed through the numerical simulations based on the configuration of the red light emission unit 103 and ray tracing.

The incidence-side polarizing element 173 is provided in the optical path of the red light LR emitted from the collimating element 163, and is arranged on the −D1 side with respect to the collimating element 163 and arranged at a position overlapping with the collimating element 163 in the D2 direction and the D3 direction. For example, the incidence-side polarizing element 173 contacts with the optical modulating element 183 from the +D1 side, and may be arranged at an appropriate interval from the optical modulating element 183 in the D1 direction.

The incidence-side polarizing element 173 corresponds to a third polarizing element, and emits predetermined polarized light of the red light LR emitted from the collimating element 163, along the D1 direction to the −D1 side. The predetermined polarized light corresponds to a third polarized light component, and is S-polarized light, for example. For example, the incidence-side polarizing element 173 is a reflection-type polarizing plate or an absorption-type polarizing plate that includes a plate surface parallel to the plane including the D2 direction and the D3 direction. Note that, when light returning to the upstream optical elements including the collimating element 161 or stray light is to be suppressed, an absorption-type polarizing plate may be adopted as the incidence-side polarizing element 171. The incidence-side polarizing element 173 transmits a part including the predetermined polarized light in the incident red light LR to the −D1 side, and reflects or absorbs the other part of the red light LR to the +D1 side.

Note that the red light LR emitted from the light source 123 includes at least P-polarized light and S-polarized light, and is random polarized light, for example. As described above, the S-polarized light component in the red light LR emitted from the light source 123 sequentially passes through the light guide element 143 and the collimating element 163, is transmitted through the incidence-side polarizing element 173, and is emitted to the −D1 side with respect to the incidence-side polarizing element 173. The P-polarized light component in the red light LR sequentially passes through the light guide element 143 and the collimating element 163 similarly to the S-polarized light component, but is reflected or absorbed by the incidence surface of the incidence-side polarizing element 173, and is emitted to the-D1 side with respect to the incidence-side polarizing element 173.

The optical modulating element 183 is provided in the optical path of the red light LR emitted from the incidence-side polarizing element 173, and is arranged on the −D1 side with respect to the incidence-side polarizing element 173 and arranged at a position overlapping with the incidence-side polarizing element 173 in the D2 direction and the D3 direction. The optical modulating element 183 corresponds to a third modulating element, and modulates the red light LR emitted from the incidence-side polarizing element 173, based on image information transmitted from an external image formation apparatus (omitted in illustration) such as a computer coupled to the optical modulating element 183.

For example, the optical modulating element 183 is a transmissive-type liquid crystal panel. The liquid crystal panel forming the optical modulating element 183 includes a plurality of pixels (omitted in illustration). Each of the pixels includes a switching element. For example, the switching element is a TFT. An electrical signal corresponding to brightness of the red light at the relative position of each of the pixels in the modulating surface of the optical modulating element 183 on an image to be projected by the projector 301 is supplied to the switching element of each of the pixels. Each of the pixels modulates a vibration direction of the red light LR incident from the incidence-side polarizing element 173 by an operation of the switching element corresponding to the above-mentioned electrical signal, and generates red image light IR. The image light IR corresponds to the third light. The optical modulating element 183 emits the image light IR generated by the liquid crystal panel, along the D1 direction to the −D1 side.

The emission-side polarizing element 177 is provided in the optical path of the image light IR emitted from the optical modulating element 183, and is arranged on the −D1 side with respect to the optical modulating element 183 and arranged at a position overlapping with the optical modulating element 183 in the D2 direction and the D3 direction. For example, the emission-side polarizing element 177 contacts with the optical modulating element 183 from the −D1 side, and may be arranged at an appropriate interval from the optical modulating element 183 in the D1 direction. The emission-side polarizing element 177 corresponds to a sixth polarizing element, and emits predetermined polarized light of the image light IR emitted from the optical modulating element 183, along the D1 direction to the −D1 side. The predetermined polarized light corresponds to a sixth polarized light component, and is P-polarized light, for example.

For example, the emission-side polarizing element 177 is a reflection-type polarizing plate or an absorption-type polarizing plate that includes a plate surface parallel to the plane including the D2 direction and the D3 direction. Note that, when light returning to the optical modulating element 183 or stray light is to be suppressed, an absorption-type polarizing plate may be adopted as the emission-side polarizing element 177. The emission-side polarizing element 177 transmits a part including the predetermined polarized light in the incident image light IR to the +D2 side, and reflects or absorbs the other part of the green light LG to the −D2 side.

The photosynthetic element 200 is arranged in a region in which the optical path of the blue image light IB emitted from the emission-side polarizing element 175, the optical path of the green image light IG emitted from the emission-side polarizing element 176, and the optical path of the red image light IR emitted from the emission-side polarizing element 177 intersect with one another. The photosynthetic element 200 synthesizes the image light IB, the image light IG, and the image light IR emitted from the emission-side polarizing elements 175, 176, and 177, and emits the synthesized light along the D2 direction to the +D2 side.

For example, the photosynthetic element 200 is a cross dichroic prism 210. The cross dichroic prism 210 includes an incidence surface 210c facing the emission surface of the emission-side polarizing element 175, an incidence surface 210d facing the emission surface of the emission-side polarizing element 176, an incidence surface 210e facing the emission surface of the emission-side polarizing element 177, an emission surface 210b, and two reflection films 211 and 212. The incidence surfaces 210c and 210e are parallel to the plane including the D2 direction and the D3 direction, and overlap with each other in the D2 direction and the D3 direction. The incidence surface 210d and the emission surface 210b are parallel to the plane including the D1 direction and the D3 direction, and overlap with each other in the D1 direction and the D3 direction.

As viewed along the D3 direction, the reflection film 211 is arranged to move from the +D2 side to the −D2 side as moving from the −D1 side to the +D1 side. As viewed along the D3 direction, the reflection film 212 is arranged to move from the −D2 side to the +D2 side as moving from the −D1 side to the +D1 side. The reflection films 211 and 212 overlap with the incidence surfaces 210c and 210e in the D2 direction, and overlap with the emission surface 210b and the incidence surface 210d in the D3 direction. The reflection film 211 reflects the light in the blue wavelength band, and transmits the light in the green wavelength band and the red wavelength band. The reflection film 212 reflects the light in the red wavelength band, and transmits the light in the blue wavelength band and the green wavelength band.

As viewed in the D3 direction, the cross dichroic prism 210 is formed of four right-angle prisms by bonding right-angle surfaces to each other while aligning right-angle vertices with the center position of the photosynthetic element 200. The four right-angle prisms of the cross dichroic prism 210 are formed of a transparent material that transmits the light in the visible wavelength band. As described above, the reflection film 211 is arranged at a right-angle surface that moves from the +D2 side to the −D2 side as moving from the −D1 side to the +D1 side, among the right-angle surfaces of the four right-angle prisms, and is formed of a dielectric multilayer film, for example. As described above, the reflection film 212 is arranged at a right-angle surface that moves from the −D2 side to the +D2 side as moving from the −D1 side to the +D1 side, among the right-angle surfaces of the four right-angle prisms.

The P-polarized light in the blue image light IB emitted from the emission-side polarizing element 175 is incident on the inside of the cross dichroic prism 210 along the D1 direction from the incidence surface 210c to the +D1 side, is transmitted through the reflection film 211, is reflected at the reflection film 212, and advances to the +D2 side. The P-polarized light in the green image light IG emitted from the emission-side polarizing element 176 is incident on the inside of the cross dichroic prism 210 along the D2 direction from the incidence surface 210d to the +D2 side, is transmitted through the reflection films 211 and 212, and advances to the +D2 side. The P-polarized light in the red image light IR emitted from the emission-side polarizing element 177 is incident on the inside of the cross dichroic prism 210 along the D1 direction from the incidence surface 210e to the −D1 side, is transmitted through the reflection film 212, is reflected at the reflection film 211, and advances to the +D2 side.

The image light IB, the image light IG, and the image light IR that are emitted from the reflection films 211 and 212 of the cross dichroic prism 210 to the +D2 side are synthesized with each other to generate full color image light IM. The cross dichroic prism 210 emits the full color image light IM along the D2 direction from the emission surface 210b to the +D2 side.

The projection optical system 250 is arranged in the optical path of the image light IM emitted from the photosynthetic element 200. The projection optical system 250 projects the image light IM emitted from the projection optical system 250 onto a screen SC arranged on the +D2 side, and enlarges and displays, on the screen SC, the image transmitted from the image formation apparatus to the optical modulating elements 181, 182, and 183.

For example, the projection optical system 250 is formed of one or more optical lenses arrayed along the D2 direction. For example, the optical lenses include a plano-convex lens, a plano-concave lens, a biconvex lens, a biconcave lens, a meniscus lens, an aspherical lens, a free-form lens, or the like.

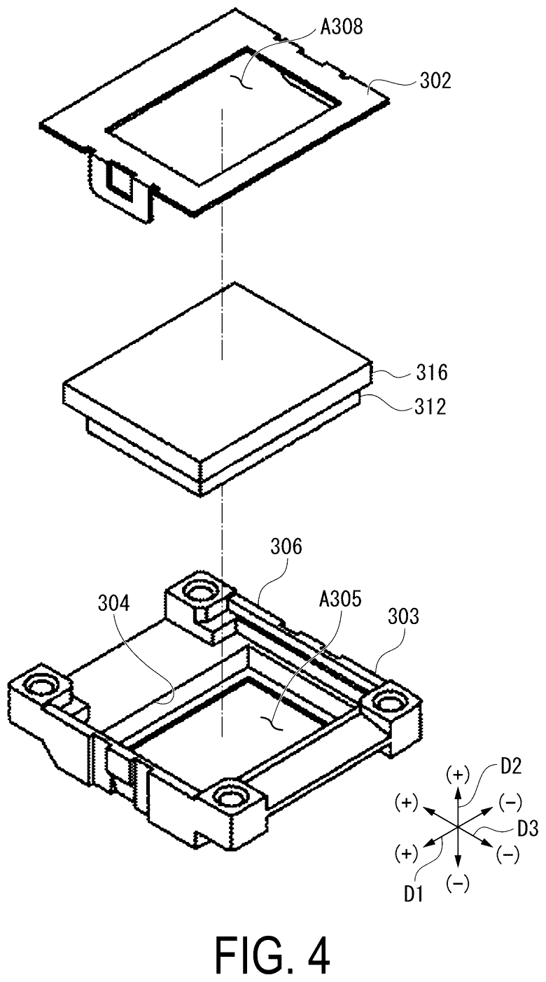

Next, configurations of main parts of the color light emission unit are described in detail, giving the green light emission unit 102 as an example. FIG. 4 is a perspective exploded view of the optical modulating element 182. The optical modulating element 182 includes a case member 303, a counter base plate 312, a liquid crystal layer 314, an element base plate 316, a sealing member 318, and a cover member 302 that are sequentially stacked and arranged along the D2 direction from the −D2 side to the +D2 side. In FIG. 4, the liquid crystal layer 314 is omitted.

The case member 303 and the cover member 302 are members for modularizing the optical modulating element 182 being a liquid crystal panel, and form a mounting case that sandwiches and mounts the counter base plate 312, the liquid crystal layer 314, and the element base plate 316 in the D2 direction. The case member 303 and the cover member 302 also function as supporting members that support the optical modulating element 182. The case member 303 and the cover member 302 correspond to fixing members in the optical modulating element 182.

The case member 303 is formed to have a frame-like shape in the plane including the D1 direction and the D3 direction. In the case member 303, a recessed portion 304 is formed. The counter base plate 312 is accommodated in the recessed portion 304 from the +D2 side. In other words, the size of the recessed portion 304 in the plane including the D1 direction and the D3 direction and the depth thereof in the D2 direction are set similarly to the size of the counter base plate 312 in the plane and the thickness thereof in the D2 direction so that the counter base plate 312 is accommodated. In the bottom wall of the recessed portion 304 in the −D2 side, an opening A305 is formed. The size of the opening A305 in the plane including the D1 direction and the D3 direction is larger than the beam area and the irradiation area of the green light LGS being the S-polarized light that is emitted from the incidence-side polarizing element 172 and is incident on the case member 303 from the −D2 side.

The case member 303 is provided with a protruding portion 306. The protruding portion 306 extends in the D3 direction along the side end of the case member 303 in the D1 direction, and extends in the D3 direction along at least a part of the side end of the case member 303 in the D1 direction. As viewed along the D2 direction, the inner wall surface of the protruding portion 306 is positioned at least on the outer side with respect to the opening A305, and is positioned further on the outer side with respect to the inner wall surface of the recessed portion 304 in the embodiment. The size of the region surrounded partially by the inner wall surface of the protruding portion 306 as viewed along the D2 direction is set similarly to the size of the element base plate 316 in the plane including the D1 direction and the D3 direction. The height of the protruding portion 306 in the D2 direction is set similarly to the thickness of the element base plate 316 in the D2 direction. In a plane including the D1 direction and the D3 direction, the element base plate 316 is supported on the inner wall surface of the protruding portion 306.

An engaged portion is formed on the outer wall surface of the case member 303, the outer wall surface extending in the D2 direction and the D3 direction along the side end in the D1 direction. The case member 303 is formed of a member capable of reflecting the green light LGS, and is formed of metal such as aluminum (Al) and stainless steel (SUS).

The cover member 302 is a plate-like member, and is formed to have a frame-like shape in the plane including the D1 direction and the D3 direction. In the cover member 302, an opening A308 is formed. The size of the opening A308 in the plane including the D1 direction and the D3 direction is larger than the beam area and the irradiation area of the green light LGS that is emitted from the element base plate 316 and is incident from the −D2 side, as described later.

An engaging portion protruding to the −D2 side is formed on the outer peripheral edge of the cover member 302, the outer peripheral edge extending in the D3 direction along the side end in the D1 direction. The engaging portion of the cover member 302 is engaged from the +D2 side with the engaged portion formed on the case member 303. With this, the cover member 302 can be removed and attached with respect to the case member 303. The cover member 302 is formed of a member similar to the case member 303, and is formed of metal such as Al and SUS.

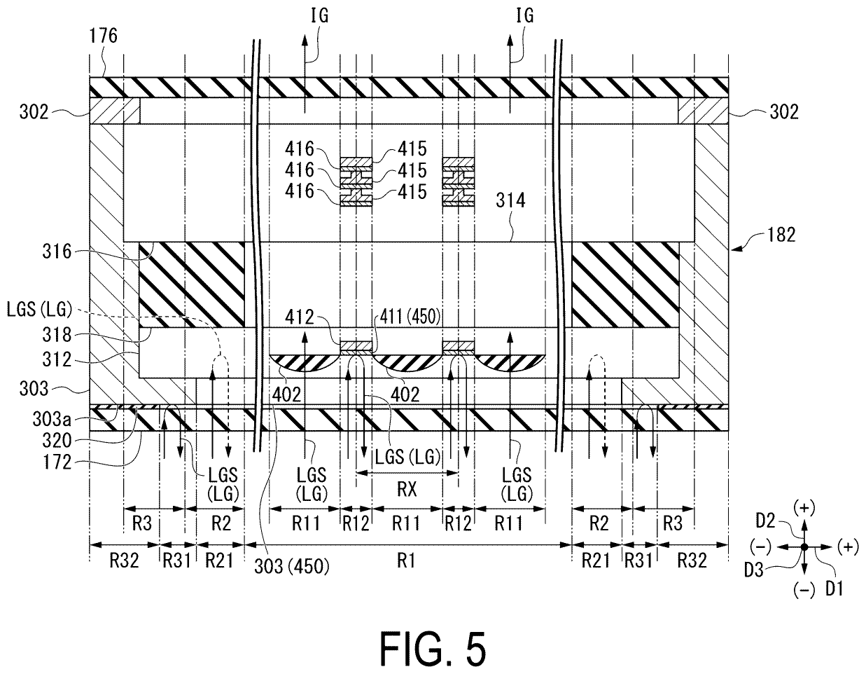

FIG. 5 is a cross-sectional view of the optical modulating element 182, and is a view taken along the plane including the D1 direction and the D2 direction. As illustrated in FIG. 5, the optical modulating element 182 is divided into a display region R1, a peripheral region R2, and a sealing region R3 from the center side to the outer peripheral edge side in the plane including the D1 direction and the D3 direction, in other words, in the direction parallel to the incidence surface on which the green light LGS is incident.

The counter base plate 312 extends in the display region R1, the peripheral region R2, and the inner region of the sealing region R3 with respect to at least the outer peripheral edge portion in the plane including the D1 direction and the D3 direction. The liquid crystal layer 314 is arranged in the display region R1 and the peripheral region R2. Note that the liquid crystal layer 314 may extend in the display region R1 and the inner region of the peripheral region R2 with respect to at least the outer peripheral edge portion in the plane including the D1 direction and the D3 direction. The element base plate 316 is formed to be larger than the counter base plate 312 in the plane including the D1 direction and the D3 direction so as to match with the case member 303 and the cover member 302 that are described above. The element base plate 316 extends in the display region R1, the peripheral region R2, and the sealing region R3. The sealing member 318 extends in the peripheral region R2 and the sealing region R3, extends in the outer region with respect to the liquid crystal layer 314 in the plane including the D1 direction and the D3 direction, and surrounds and seals the liquid crystal layer 314.

In the display region R1, the plurality of pixels of the optical modulating element 182 are formed. In other words, the display region R1 is a region in which the plurality of pixels are arranged, and is a region in which the incident green light LGS is converted into the image light IG. The display region R1 is divided into a plurality of pixel regions R11 and a plurality of inter-pixel regions R12 in a direction parallel to the plane including the D1 direction and the D3 direction. Each of the pixel regions R11 corresponds to an opening portion, and is a region in which each of the pixels is formed. Each of the inter-pixel regions R12 is a region that is interposed between the adjacent pixel regions R11 and R11 in a direction parallel to the plane including the D1 direction and the D3 direction. A region RX occupied by one pixel and a memory cell is a region between the centers of the adjacent inter-pixel regions R12 in the plane including the D1 direction and the D3 direction.

In each of the pixel regions R11 of the counter base plate 312, a micro-lens 402 is arranged. The micro-lens 402 is formed of a material transparent to the green light LG, and transmits the green light LGS transmitted through the incidence-side polarizing element 172 to the +D2 side while condensing the green light LGS in the plane including the D1 direction and the D3 direction. For example, the micro-lens 402 is a plano-convex lens including an incidence surface formed of a curved surface protruding to the −D2 side and an emission surface formed of a flat surface parallel to the D1 direction and the D3 direction, and may be an optical lens other than a plan-convex lens as long as the green light LGS can be condensed as described above.

In each of the inter-pixel regions R12 of the counter base plate 312, a metal layer 411 and a support layer 412 are provided. The metal layer 411 is a reflection layer on which the green light LGS is incident on the inter-pixel region R12 from the −D2 side is incident at the upstream-most stage, and is formed of a material capable of reflecting the green light LG. For example, the metal forming the metal layer 411 is an Al alloy, and is the same metal as a conductive layer forming each electrode provide to the element base plate 316.

The support layer 412 is formed on the +D2 side of the metal layer 411, is stacked on the +D2 side of the metal layer 411, and overlaps with the metal layer 411 in the D1 direction and the D3 direction. The support layer 412 is provided as a foundation of the metal layer 411. When the metal layer 411 is arranged independently, the support layer 412 may be omitted. For example, the material of the support layer 412 is titanium nitride (TiN), and may be the same material as the material of the layer forming the foundation of each electrode provided to the element base plate 316 or the material of a contact plug coupling the electrodes to each other in the D2 direction.

In each of the pixel regions R11 of the element base plate 316, a transparent electrode for aligning the liquid crystals in the liquid crystal layer 314 is provided. Details of the configuration of the stacking structure are similar to those of a publicly-known electro-optical element or semiconductor device.

In each of the inter-pixel regions R12 of the element base plate 316, a conductive layer 415 and a support layer 416 are provided. The conductive layer 415 forms a word line or a bit line for supplying a driving voltage to a switching element or the like formed in the pixel region R11, or forms a common wiring line or the like arranged on the −D2 side with respect to the word line or the bit line. The conductive layer 415 also functions as a contact plug for coupling the respective wiring lines described above in the D2 direction. The plurality of conductive layers 415 include a conductive stacking structure (omitted in illustration) forming a TFT being the switching element described above. For example, the material of the conductive layer 415 is an Al alloy or tungsten (W).

The support layer 416 is provided as a foundation of the conductive layer 415, and supports the conductive layer 415 in the D2 direction. The material of the support layer 416 is a conductive material excellent in microhardness, flatness, and thermal stability, and is TiN, for example.

In the plane including the D1 direction and the D3 direction, the width of the metal layer 411 and the support layer 412 of the counter base plate 312 is at least equivalent to the width of the conductive layer 415 and the support layer 416 of the element base plate 316, and is smaller than the width of the conductive layer 415 and the support layer 416 of the element base plate 316. The width of the metal layer 411 and the support layer 412 is less than the width of the conductive layer 415 and the support layer 416. Thus, the green light LGS incident on the pixel region R11 of the element base plate 316 is not blocked, and degradation of the utilization efficiency of the green light LG can be suppressed. Moreover, as the width of the metal layer 411 and the support layer 412 is closer to the width of the conductive layer 415 and the support layer 416, the light amount of the green light LGS reflected at the metal layer 411 to the −D2 side is secured more.

In the peripheral region R2 of the counter base plate 312 and the element base plate 316, a layer structure similar to the display region R1, an electrode structure (omitted in illustration), and the like are provided. Note that the metal layer 411, the conductive layer 415, or the support layers 412 and 416 (omitted in illustration) provided in the peripheral region R2 are not intended to contribute to conversion of the green light LGS and generation of the image light IG. The green light LGS is converted into the image light IG by passing through the liquid crystal layer 314 arranged in the pixel, that is, the memory cell in each of the regions RX in the display region R1. Thus, the size of the display region R1 in the plane including the D1 direction and the D3 direction is set so as to match with the size required for the image light IM before the image light IM is enlarged and projected from the projector 301.

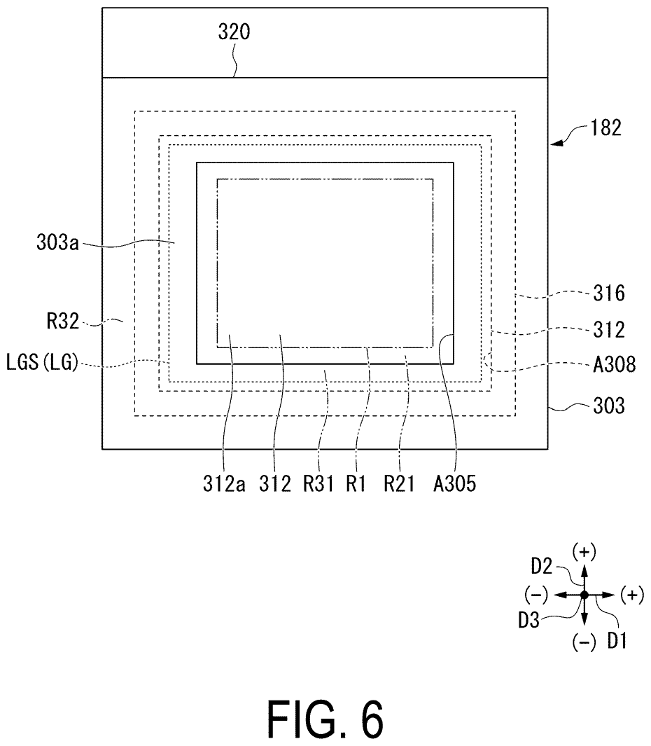

FIG. 6 is a plane view of the optical modulating element 182, and is a view as the optical modulating element 182 is viewed along the D2 direction from the −D2 side on which the green light LG is incident. As illustrated in FIG. 6, a plate surface 312a of the counter base plate 312 on the −D2 side is exposed from the opening A305 formed in the case member 303. A plate surface 312a corresponds to a first surface of the counter base plate 312 of the optical modulating element 182.

In the optical modulating element 182, the display region R1 in which the green light LGS is converted into the image light IG is positioned on the inner side with respect to the opening A305 that is formed in the case member 303 in the plane including the D1 direction and the D3 direction so as to be orthogonal to the D2 direction. A region on the outer side with respect to the display region R1 and the inner side with respect to the opening A305 in a direction parallel to the plane including the D1 direction and the D3 direction is a partition region R21.

The partition region R21 is provided considering a manufacturing error of the case member 303 and the cover member 302, so as to prevent the end portion of the case member 303, which forms the edge of the opening A305, and the end portion of the cover member 302, which forms the edge of the opening A308, from being positioned on the inner side with respect to the display region R1. Thus, the dimension of the partition region R21 is the D1 direction and the D3 direction is set to be a dimension slightly larger than a manufacturing error of the case member 303 and the cover member 302. As viewed in the D2 direction, the partition region R21 includes at least the inner side of the peripheral region R2 in the plane including the D1 direction and the D3 direction.

In the optical modulating element 182, irradiation with the green light LGS emitted from the incidence-side polarizing element 172 to the +D2 side is performed appropriately on the outer side in the plane including the D1 direction and the D3 direction with respect to the opening A305 formed in the case member 303. The region on which the green light LGS is incident on the outer side with respect to the opening A305 is a margin region R31.

As viewed in the D2 direction, in the plane including the D1 direction and the D3 direction, the margin region R31 includes an outer region of the peripheral region R2 with respect to the partition region R21, and may further include at least a part of an inner region of the sealing region R3. Note that the size of the emission end 142b of the light guide element 142 in the plane including the D1 direction and the D3 direction is set similarly to the size of the region occupied by the display region R1, the partition region R21, and the margin region R31 of the optical modulating element 182 in the same plane, in other words, the region on which the green light LGS is incident.

A surface 303a of the case member 303 on the −D2 side, which is parallel to the plane including the D1 direction and the D3, is divided into the margin region R31 and a light shielding region R32 on the outer side with respect to the margin region R31. The surface 303a corresponds to a first surface of the case member 303 of the optical modulating element 182. As described above, the case member 303 is formed of a member that reflects the green light LGS incident from the −D2 side to the −D2 side. The surface 303a of the light shielding region R32 is provided with a light shielding layer 320 that blocks or absorbs the green light LGS. Even when the green light LG emitted from the light guide element 142 and the green light LGS emitted from the incidence-side polarizing element 172 are unintentionally incident on the light shielding region R32 on the outer side with respect to the margin region R31, generation of stray light being the green light LGS reflected at the surface 303a of the light shielding region R32 can be suppressed because the light shielding layer 320 is arranged in the light shielding region R32.

The green light LGS incident on the display region R1 of the optical modulating element 182 from the −D2 side along the D2 direction is reflected at the metal layer 411 of the plurality of inter-pixel regions R12 of the counter base plate 312 to the −D2 side. When the metal layer including the metal layer 411 is arranged in the peripheral region R2 of the counter base plate 312, the green light LGS incident on the partition region R21 of the optical modulating element 182 from the −D2 side along the D2 direction is reflected at the metal layer including the metal layer 411 to the −D2 side. The green light LGS incident on the margin region R31 of the optical modulating element 182 from the −D2 side along the D2 direction is reflected at the surface 303a of the case member 303 to the −D2 side.

The green light LGS that is reflected from the optical modulating element 182 to the −D2 side as described above passes through the incidence-side polarizing element 172, is incident on the light guide element 142, and propagates to the −D2 side in the light guide element 142 similarly to the green light LGP reflected at the incidence-side polarizing element 172 to the −D2 side. In other words, similarly to the green light LGP illustrated in FIG. 3, the green light LGS reflected at the optical modulating element 182 to the −D2 side is re-incident on the phosphor 124 of the light source 122, and contributes to excitation and light emission of the phosphor 124. As a result, the utilization efficiency of the green light LG in the green light emission unit 102 and the projector 301 is improved.

The metal layer 411 of the counter base plate 312 of the optical modulating element 182 and the case member 303 in the margin region R31 form a reflection portion 450 that reflects, to the −D2 side, the green light LGS incident along the D2 direction from the −D2 side.

The projector 301 of the embodiment described above includes the light source (second light source) 121, the light source (first light source) 122, the light source (third light source) 123, the light guide element (second light guide element) 141, the light guide element (first light guide element) 142, the light guide element (third light guide element) 143, the collimating element (second collimating element) 161, the collimating element (first collimating element) 162, the collimating element (third collimating element) 163, the optical modulating element (second optical modulating element) 181, the optical modulating element (first optical modulating element) 182, the optical modulating element (third optical modulating element) 183, the photosynthetic element 200, and the projection optical system 250. The light source 122 emits the green light (first light) LG in the green wavelength band (first wavelength band). The light source 121 emits the blue light (second light) LB in the blue wavelength band (second wavelength band) different from the green wavelength band. The light source 123 emits the red light (third light) LR in the red wavelength band (third wavelength band) different from the blue wavelength band and the green wavelength band. The light guide element 142 includes the incidence end (first incidence end) 142a on which the green light LG emitted from the light source 122 is incident and the emission end (first emission end) 142b from which the green light LG is emitted, and equalizes the illumination intensity (in-plane illumination intensity) of the green light LG in the plane including the D1 direction and the D3 direction. The light guide element 141 includes the incidence end (second incidence end) 141a on which the blue light LB emitted from the light source 121 is incident and the emission end (second emission end) 141b from which the blue light LB is emitted, and equalizes the illumination intensity (in-plane illumination intensity) of the blue light LB in the plane including the D2 direction and the D3 direction. The light guide element 143 includes the incidence end (third incidence end) 143a on which the red light LR emitted from the light source 123 is incident and the emission end (third emission end) 143b from which the red light LR is emitted, and equalizes the illumination intensity (in-plane illumination intensity) of the red light LR in the plane including the D1 direction and the D3 direction. The optical modulating element (first optical modulating element) 182 modulates the green light LG emitted from the collimating element 162, based on the image information. The optical modulating element (second optical modulating element) 181 modulates the blue light LB emitted from the collimating element 161, based on the image information. The optical modulating element (third optical modulating element) 183 modulates the red light LR emitted from the collimating element 163, based on the image information. The photosynthetic element 200 synthesizes the image light (first light) IG emitted from the optical modulating element 182, the image light (second light) IB emitted from the optical modulating element 181, and the image light (third light) IR emitted from the optical modulating element 183, and emits the synthesized light. The projection optical system 250 projects the image light (light) IM emitted from the photosynthetic element 200.

In the projector 301 of the embodiment, the light of the three colors emitted from the light sources 121, 122, and 123, in other words, the blue light LB, the green light LG, and the red light LR are directly converted into the image light IB, the image light IG, and the image light IR by the optical modulating elements 181, 182, and 183, the image light IB, the image light IG, and the image light IR are synthesized by the photosynthetic element 200, and the full color image light IM being generated is projected. In contrast, in a projector in the related art, white light is generated, the white light is divided into light of three colors by a color separating element or a color separating optical system, each color light is converted into image light by an optical modulating element, the image light is synthesized by a photosynthetic element to generate full color image light, and the full color image light is projected. In the projector 301 of the embodiment, a photosynthetic element or a photo synthetic optical system that synthesizes the light of the three colors to generate white light and a color separating element or a color separating optical system that separates the white light into the light of the three colors may not be provided upstream of the optical modulating elements corresponding to the light of the three colors. Thus, as compared to a projector in the related art, the number of components and the number of devices can be reduced, and the size increase can be suppressed. According to the projector 301 of the embodiment, the size reduction can be achieved as compared to a projector in the related art.

In the projector 301 of the embodiment, in the optical modulating element 182, the metal layer 411 being the reflection portion 450 is provided on the plate surface (first surface) 312a side of the counter base plate 312 on which the green light (first light) LGS is incident in the D2 direction and in the inter-pixel region (region) R12 other than the image region (opening portion) R11 in the display region R1 in a direction parallel to the plane including the D1 direction and the D3 direction.

In the projector 301 of the embodiment, the green light LGS that is emitted from the light guide element 142 and is incident on the display region R1 of the optical modulating element 182 is reflected toward the light guide element 142 by the metal layer 411 being the reflection portion 450 in the display region R1, is guided again by the light guide element 142, is incident on the phosphor 124 of the light source 122, and re-utilized for emission of the green light LG. According to the projector 301 of the embodiment, the utilization efficiency of the green light LG can be improved.

In the projector 301 of the embodiment, for example, when the case member 303 of the optical modulating element 182 is formed of a member that does not reflect the green light LG, or the light shielding layer 320 is also provided to the surface 303a of the case member 303 in the margin region R31, the reflection portion 450 is formed only by the metal layer 411 in the display region R1. In this case, according to the projector 301 of the embodiment, improvement of the utilization efficiency of the green light LG can also be expected.

In the projector 301 of the embodiment, the optical modulating element 182 includes the reflection portion 450 on the plate surface (first surface) 312a side of the counter base plate 312 and the surface (first surface) 303a of the case member 303 on which the green light (first light) LGS is incident in the D2 direction and on the outer side of the display region R1 in a direction parallel to the plane including the D1 direction and the D3 direction. For example, the reflection portion 450 on the outer side of the display region R1 is formed of the surface 303a in the margin region R31 of the case member 303 formed of metal. Note that, when a metal layer is arranged in the partition region R21 of the peripheral region R2 of the counter base plate 312 of the optical modulating element 182, the reflection portion 450 on the outer side of the display region R1 further includes a metal layer in the partition region R21.

In the projector 301 of the embodiment, the green light LGS that is emitted from the light guide element 142 and is incident on the display region R1 of the optical modulating element 182 is reflected toward the light guide element 142 by the case member 303 being the reflection portion 450 or the reflection layer in the partition region R21, is guided again by the light guide element 142, is incident on the phosphor 124 of the light source 122, and re-utilized for emission of the green light LG. According to the projector 301 of the embodiment, the utilization efficiency of the green light LG can be improved.

In the projector 301 of the embodiment, for example, when the conductive layer 415 or other metal layers that reflect the green light LG is not arranged in the display region R1 of the counter base plate 312 of the optical modulating element 182, the reflection portion 450 is formed only by the case member 303 on the outer side with respect to the display region R1. In this case, according to the projector 301 of the embodiment, improvement of the utilization efficiency of the green light LG can also be expected.

In the projector 301 of the embodiment, the reflection portion 450 is provided between the display region R1, and the partition region (light incidence region) R21 and the margin region (light incidence region) R31 on which the green light LGS is incident. The light shielding layer (light shielding portion) 320 is provided to the surface 303a between the outer side of the margin region R31 of the case member 303 and the outer peripheral end portion (end portion) of the optical modulating element 182 in the plane including the D1 direction and the D3 direction.

In the projector 301 of the embodiment, the green light LGS that is emitted from the light guide element 142 and incident on the display region R1 of the optical modulating element 182 is reflected toward the light guide element 142 by the metal layer of the counter base plate 312 in the partition region R21 and the case member 303 in the margin region R31, is incident on the phosphor 124 of the light source 122, and is re-utilized for emission of the green light LG. According to the projector 301 of the embodiment, the utilization efficiency of the green light LG can be improved. Further, in the projector 301 of the embodiment, the green light LGS incident on the light shielding region R32 on the outer side with respect to the margin region R31 is blocked by the light shielding layer 320. According to the projector 301 of the embodiment, generation of stray light caused by the green light LGS incident on the light shielding region R32 can be suppressed.

In the projector 301 of the embodiment, the reflection portion 450 is provided to the portion (partition portion) in the partition region R21 of the counter base plate (base plate) 312 on the plate surface (first surface) 312a side in the optical modulating element 182.

In the projector 301 of the embodiment, the green light LGS that is emitted from the light guide element 142 and is incident on the display region R1 of the optical modulating element 182 is reflected toward the light guide element 142 by the metal layer 411 of the counter base plate 312 in the partition region R21 or a constituent element formed of a material capable of reflecting the green light LGS other than the metal layer 411, is incident on the phosphor 124 of the light source 122, and re-utilized for emission of the green light LG. According to the projector 301 of the embodiment, the utilization efficiency of the green light LG can be improved. Further, according to the projector 301 of the embodiment, the partition region R21 is provided. Thus, a manufacturing error of the case member 303 and the cover member 302 is allowed.

In the projector 301 of the embodiment, the reflection portion 450 is provided the case member (fixing member) 303 that supports the counter base plate 312, the liquid crystal layer 314, the sealing member 318, and the element base plate 316 in the D2 direction in collaboration with the cover member 302 in the optical modulating element 182.

In the projector 301 of the embodiment, the green light LGS that is emitted from the light guide element 142 and is incident on the display region R1 of the optical modulating element 182 is reflected toward the light guide element 142 by the case member 303, is incident on the phosphor 124 of the light source 122, and is re-utilized for emission of the green light LG. According to the projector 301 of the embodiment, the utilization efficiency of the green light LG can be improved.

In the projector 301 of the embodiment, the reflection portion 450 is provided at the metal layer 411 of the counter base plate (base plate) 312 that overlaps with the conductive layer (wiring layer) 415 in a direction parallel to the plane including the D1 direction and the D3 direction in plan view, the conductive layer (wiring layer) 415 being formed in the periphery of the pixel region (opening portion) R11.

In the projector 301 of the embodiment, the green light LGS incident on the counter base plate 312, the liquid crystal layer 314, and the element base plate 316 in the pixel region R11 is not blocked by the metal layer 411 of the reflection portion 450, and the utilization efficiency of the green light LG can further be improved.

In the projector 301 of the embodiment, the focal length f2 of the collimating element 162 is more than the length g2 of the light guide element 142 from the incidence end 142a to the emission end 142b. The focal length f1 of the collimating element 161 is more than the length g1 of the light guide element 141 from the incidence end 141a to the emission end 141b. The focal length f3 of the collimating element 163 is more than the length g3 of the light guide element 143 from the incidence end 143a to the emission end 143b.

In the projector 301 of the embodiment, the size increase of the blue light emission unit 101, the green light emission unit 102, and the red light emission unit 103 is suppressed in the three-plate projector. According to the projector 301 of the embodiment, the size reduction of the entire apparatus can be achieved.

In the projector 301 of the embodiment, the light source 122 includes the LED main body (light emitter) 125 and the phosphor 124 that emits the green light LG being fluorescence by the blue light (excitation light) emitted from the LED main body 125.

In the projector 301 of the embodiment, the green light LGS reflected by the reflection portion 450 of the optical modulating element 182 is re-incident on the phosphor 124 from the +D2 side, and is used for re-excitation of the phosphor 124. According to the projector 301 of the embodiment, the utilization efficiency of the green light LG can further be improved.

In the projector 301 of the embodiment, the cross-sectional shapes of the light guide elements 141 and 143, which are orthogonal to the optical axis and the D1 direction, are a rectangular shape, and the cross-sectional shape of the light guide element 142, which is orthogonal to the optical axis and the D2 direction, is a rectangular shape.

In the projector 301 of the embodiment, the light guide elements 141, 142, and 143 can easily generate the blue light LB, the green light LG, and the red light LR each having a rectangular shape within the plane orthogonal to the optical axis of the color light and the equalized illumination intensity. According to the projector 301 of the embodiment, the color light according to the rectangular shapes of the optical modulating elements 181, 182, and 183 can be generated easily.

The projector 301 of the embodiment further includes the incidence-side polarizing element (second polarizing element) 171, the incidence-side polarizing element (first polarizing element) 172, and the incidence-side polarizing element (third polarizing element) 173. The incidence-side polarizing element 171 is arranged between the collimating element 161 and the optical modulating element 181, transmits a part including the S-polarized light component (second polarized light component) in the blue light LB, and reflects the P-polarized light component being the other part in the blue light LB. The incidence-side polarizing element 172 is arranged between the collimating element 162 and the optical modulating element 182, transmits a part including the S-polarized light component (first polarized light component) in the green light LG, and reflects the P-polarized light component being the other part in the green light LG. The incidence-side polarizing element 173 is arranged between the collimating element 163 and the optical modulating element 183, transmits a part including the S-polarized light component (third polarized light component) in the red light LR, and reflects the P-polarized light component being the other part in the red light LR. In the projector 301 of the embodiment, the other part in the blue light LB is incident on the light guide element 141 towards the light source 121. The other part in the green light LG is incident on the light guide element 142 towards the light source 122. The other part in the red light LR is incident on the light guide element 143 towards the light source 123.

In the projector 301 of the embodiment, the other parts of the blue light LB, the green light LG, and the red light LR that are reflected by the incidence-side polarizing elements 171, 172, and 173 and are emitted from the incidence-side polarizing elements 171, 172, and 173 can be incident on the light sources 121, 122, and 123, respectively. For example, among the light sources 121, 122, and 123, the light source 122 includes the phosphor 124. Thus, the other part in the green light LG towards the light source 122 is incident on the phosphor 124, and contributes to excitation of the phosphor 124. Further, when the base plates 111, 112, and 113 of the light sources 121, 122, and 123 have reflectivity, the other parts of the blue light LB, the green light LG, and the red light LR towards the light sources 121, 122, and 123 are reflected at the base plates 111, 112, and 113, respectively, are re-incident on the light guide elements 141, 142, and 143, and re-used. According to the projector 301 of the embodiment, the other parts of the blue light LB, the green light LG, and the red light LR that are reflected at the incidence-side polarizing elements 171, 172, and 173, respectively, are incident again on the light guide elements 141, 142, and 143. Thus, the utilization efficiency of the blue light LB, the green light LG, and the red light LR can be improved.

In the projector 301 of the embodiment, the cross-sectional area of the emission end 141b of the light guide element 141 in the D2 direction and the D3 direction is larger than the cross-sectional area of the incidence end 141a the light guide element 141 in the same direction. The cross-sectional area of the emission end 142b of the light guide element 142 in the D1 direction and the D3 direction is larger than the cross-sectional area of the incidence end 142a the light guide element 142 in the same direction. The cross-sectional area of the emission end 143b of the light guide element 143 in the D2 direction and the D3 direction is larger than the cross-sectional area of the incidence end 143a the light guide element 143 in the same direction.

In the projector 301 of the embodiment, from incidence on the light guide elements 141, 142, and 143 through the incidence ends 141a, 142a, and 143a to emission from the emission ends 141b, 142b, and 143b, the illumination intensity distribution of the blue light LB, the green light LG, and the red light LR is equalized, and the irradiation area of each color light is expanded. According to the projector 301 of the embodiment, the blue light LB, the green light LG, and the red light LR are emitted from the light sources 121, 122, and 123 that have light emission surfaces smaller than the respective modulating surfaces of the optical modulating elements 181, 182, and 183, and the sizes of the blue light LB, the green light LG, and the red light LR in the plane orthogonal to the optical axes, in other words, the irradiation areas can be expanded easily according to the respective modulating surfaces of the optical modulating elements 181, 182, and 183.

In the projector 301 of the embodiment, the light guide elements 141, 142, and 143 are formed of metal or glass such as optical glass.

As described above, in the projector 301 of the embodiment, the light guide elements 141, 142, and 143 are formed of plate-like members formed of a transparent material including glass such as optical glass. According to the projector 301 of the embodiment, heat radiation and heat resistance of the light guide elements 141, 142, and 143 can be improved.

Note that, in a modification example of the projector 301 of the embodiment, the plate-like members forming the light guide elements 141, 142, and 143 may be formed of metal. In other words, for example, the light guide elements 141, 142, and 143 may be formed of metal plate-like members that reflect the blue light LB, the green light LG, and the red light LR. In this case, similarly to a case where the reflection film is provided to the plate surface facing the internal space of the plate-like members formed of a transparent material, the plate surfaces of the plate-like members that face the light guide elements 141, 142, and 143 act as the reflection surfaces 141r, 142r, and 143r. The respective parts of the blue light LB, the green light LG, and the red light LR that are incident on the internal spaces of the light guide elements 141, 142, and 143 through the incidence ends 141a, 142a, and 143a are reflected at the plate surfaces of the plate-like members that face the internal spaces of the light guide elements 141, 142, and 143, and advance along the optical axes. In the modification example of the projector 301 of the embodiment, heat radiation and heat resistance of the light guide elements 141, 142, and 143 can also be improved.

In the projector 301 of the embodiment, the light guide elements 141, 142, and 143 are hollow, and the reflection films 251, 252, and 253 are provided to the surfaces (inner surfaces) facing the internal spaces of the plate-like members forming the light guide elements 141, 142, and 143.

In the projector 301 of the embodiment, the respective parts of the blue light LB, the green light LG, and the red light LR that are incident on the light guide elements 141, 142, and 143 are mirror-reflected at the reflection films 251, 252, and 253, and propagate in the internal spaces of the light guide elements 141, 142, and 143. According to the projector 301 of the embodiment, the losses of the blue light LB, the green light LG, and the red light LR inside the light guide elements 141, 142, and 143 can be suppressed.

Note that, in another modification example of the projector 301 of the embodiment, the light guide elements 141, 142, and 143 may be solid, and may be formed of a transparent material such as optical glass. In this case, the plate surfaces of the reflectors that face the external spaces of the light guide elements 141, 142, and 143, in other words, the side surfaces 141s, 142s, and 143s act as the reflection surfaces 141r, 142r, and 143r. The respective parts of the blue light LB, the green light LG, and the red light LR that are incident on the reflectors of the light guide elements 141, 142, and 143 through the incidence ends 141a, 142a, and 143a are totally reflected at the reflection surfaces 141r, 142r, and 143r facing the external spaces of the reflectors, and advance along the optical aces. Further, the light guide elements 141, 142, and 143 may be solid, may be formed of a transparent material such as optical glass, and the side surfaces 141s, 142s, and 143s may be provided with the reflection films 251, 252, and 253. In the other modification example of the projector 301 of the embodiment, the losses of the blue light LB, the green light LG, and the red light LR inside the light guide elements 141, 142, and 143 can also be suppressed.

In the projector 301 of the embodiment, the cross-sectional shapes of the light guide elements 141, 142, and 143 are a rectangular shape. 7 degrees≤α≤22 degrees is satisfied, where α is the gradient angle of the side surfaces including the short sides of the light guide elements 141, 142, and 143, in other words, the angle formed with respect to the optical axes. 14 degrees≤β≤36 degrees is satisfied, where β is the gradient angle of the side surfaces including the long sides of the light guide elements 141, 142, and 143. The reflection films 251, 252, and 253 are provided to the surfaces (inner surfaces) facing the internal spaces of the plate-like members of the light guide elements 141, 142, and 143 that are hollow. As illustrated in FIG. 2, 60 degrees≤θᵢₙ≤90 degrees is satisfied, where θᵢₙ is the incident angle of the light incident on the reflection films 251, 252, and 253 when the reflectance of each of the blue light LB, the green light LG, and the red light LR at the reflection films 251, 252, and 253 is the highest.

In the projector 301 of the embodiment, the blue light LB, the green light LG, and the red light LR are emitted from the light sources 121, 122, and 123, and are radially incident through the incidence ends 141a, 142a, and 143a while forming the predetermined angle with respect to the optical axes inside the light guide elements 141, 142, and 143. When the reflection films 251, 252, and 253 are designed as described above, the intensity of the blue light LB, the green light LG, and the red light LR that are reflected at the reflection films 251, 252, and 253 is high. According to the projector 301 of the embodiment, the losses of the blue light LB, the green light LG, and the red light LR at the light guide elements 141, 142, and 143 can be suppressed as much as possible, and the utilization efficiency of the blue light LB, the green light LG, and the red light LR can be improved.

The projector 301 of the embodiment further includes the emission-side polarizing element (fifth polarizing element) 175, the emission-side polarizing element (fourth polarizing element) 176, and the emission-side polarizing element (sixth polarizing element) 177. The emission-side polarizing element 175 is arranged between the optical modulating element 181 and the photosynthetic element 200, transmits a part including the P-polarized light (fifth polarized light component) in the image light (light) IB emitted from the optical modulating element 181, and absorbs the other part other than the P-polarized light component in the image light IB. The emission-side polarizing element 176 is arranged between the optical modulating element 182 and the photosynthetic element 200, transmits a part including the P-polarized light (fourth polarized light component) in the image light (light) IG emitted from the optical modulating element 182, and absorbs the other part other than the P-polarized light component in the image light IG. The emission-side polarizing element 177 is arranged between the optical modulating element 183 and the photosynthetic element 200, transmits a part including the P-polarized light (sixth polarized light component) in the image light (light) IR emitted from the optical modulating element, and absorbs the other part other than the P-polarized light component in the image light IR.

In the projector 301 of the embodiment, the emission-side polarizing elements 175, 176, and 177 formed of, for example, absorption-type polarizing plates or polarizing elements cause the P-polarized light components in the image light IB, the image light IG, and the image light IR to be incident on the photosynthetic element 200, and absorbs the parts other than the P-polarized light components in the image light IB, the image light IG, and the image light IR. The other parts in the image light IB, IG, and IR can be prevented from returning to the optical modulating elements 181, 182, and 183 or becoming stray light.

Although the preferred embodiments of the present disclosure have been described in detail above, the present disclosure is not limited to the particular embodiments, and various variations and changes are possible within the scope of the gist of the present disclosure as described in the claims.

For example, similarly to the green light emission unit 102, the blue light emission unit 101 or the red light emission unit 103 may include a phosphor in which an LED forming the light source 121 or 123 is excited by excitation light emitted from an LED main body to emit the blue light LB or the red light LR. Further, the LED of the light source 122 of the green light emission unit 102 may not include the phosphor 124, and the light source 122 may be configured by an LED that directly emits the green light LG. Further, the polarized light component that is transmitted through the incidence-side polarizing plate arranged in the optical path of each color light may be a common component, or may not be common.

Further, the projector of the embodiment described above, which is a transmissive-type three-panel projector, may be a reflection-type three-panel projector.

### Overview of The Present Disclosure

An overview of the present disclosure is provided below as the appendices.

### Appendix 1

A projector including a first light source configured to emit first light in a first wavelength band, a second light source configured to emit second light in a second wavelength band different from the first wavelength band, a third light source configured to emit third light in a third wavelength band different from the first wavelength band and the second wavelength band, a first light guide element including a first incidence end on which the first light emitted from the first light source is incident and a first emission end from which the first light is emitted, and being configured to equalize in-plane illumination intensity of the first light, a second light guide element including a second incidence end on which the second light emitted from the second light source is incident and a second emission end from which the second light is emitted, and being configured to equalize in-plane illumination intensity of the second light, a third light guide element including a third incidence end on which the third light emitted from the third light source is incident and a third emission end from which the third light is emitted, and being configured to equalize in-plane illumination intensity of the third light, a first collimating element configured to collimate the first light emitted from the first light guide element, a second collimating element configured to collimate the second light emitted from the second light guide element, a third collimating element configured to collimate the third light emitted from the third light guide element, a first optical modulating element configured to modulate the first light emitted from the first collimating element, based on image information, a second optical modulating element configured to modulate the second light emitted from the second collimating element, based on image information, a third optical modulating element configured to modulate the third light emitted from the third collimating element, based on image information, a photosynthetic element configured to synthesize and emit the first light emitted from the first optical modulating element, the second light emitted from the second optical modulating element, and the third light emitted from the third optical modulating element, and a projection optical system configured to project the light emitted from the photosynthetic element, wherein the first optical modulating element is provided with a reflection portion on a first surface side on which the first light is incident and in a region other than an opening portion of a display region.

With the configuration in Appendix 1, an optical component used for generating white light or an optical component for separating light for each color is not required, and the number of components is reduced. Thus, an increase in size of the three-panel projector can be prevented, and a small projector can be achieved. Further, with the configuration in Appendix 1, the reflection portion of the first optical modulating element can reflect the first light toward the first light source. Thus, the utilization efficiency of the first light can be improved.

### Appendix 2

A projector including a first light source configured to emit first light in a first wavelength band, a second light source configured to emit second light in a second wavelength band different from the first wavelength band, a third light source configured to emit third light in a third wavelength band different from the first wavelength band and the second wavelength band, a first light guide element including a first incidence end on which the first light emitted from the first light source is incident and a first emission end from which the first light is emitted, and being configured to equalize in-plane illumination intensity of the first light, a second light guide element including a second incidence end on which the second light emitted from the second light source is incident and a second emission end from which the second light is emitted, and being configured to equalize in-plane illumination intensity of the second light, a third light guide element including a third incidence end on which the third light emitted from the third light source is incident and a third emission end from which the third light is emitted, and being configured to equalize in-plane illumination intensity of the third light, a first collimating element configured to collimate the first light emitted from the first light guide element, a second collimating element configured to collimate the second light emitted from the second light guide element, a third collimating element configured to collimate the third light emitted from the third light guide element, a first optical modulating element configured to modulate the first light emitted from the first collimating element, based on image information, a second optical modulating element configured to modulate the second light emitted from the second collimating element, based on image information, a third optical modulating element configured to modulate the third light emitted from the third collimating element, based on image information, a photosynthetic element configured to synthesize and emit the first light emitted from the first optical modulating element, the second light emitted from the second optical modulating element, and the third light emitted from the third optical modulating element, and a projection optical system configured to project the light emitted from the photosynthetic element, wherein the first optical modulating element includes a reflection portion on a first surface side on which the first light is incident and an outer side of a display region.

With the configuration in Appendix 2, an optical component used for generating white light or an optical component for separating light for each color is not required, and the number of components is reduced. Thus, an increase in size of the three-panel projector can be prevented, and a small projector can be achieved. Further, with the configuration in Appendix 2, the reflection portion of the first optical modulating element can reflect the first light toward the first light source. Thus, the utilization efficiency of the first light can be improved.

### Appendix 3

A projector according to Appendix 1 or Appendix 2, wherein the reflection portion is provided between the display region and a light incidence region on which the first light is incident, and a light shielding portion is provided between an outer side of the light incidence region to an end portion of the first optical modulating element.

With the configuration in Appendix 3, the utilization efficiency of the first light reflected at the reflection portion can be improved, and generation of stray light can be suppressed.

### Appendix 4

A projector according to any one of Appendix 1 to Appendix 3, wherein the reflection portion is provided to a partition portion of a base plate on a side close to the first surface of the first optical modulating element.

With the configuration in Appendix 4, the utilization efficiency of the first light reflected at the partition portion of the first optical modulating element can be improved, and a manufacturing error of the fixing member can be allowed.

### Appendix 5

A projector according to any one of Appendix 1 to Appendix 4, wherein the reflection portion is provided to a fixing member of the first optical modulating element.

With the configuration in Appendix 5, the utilization efficiency of the first light reflected at the fixing member can be improved.

### Appendix 6

A projector according to any one of Appendix 1 to Appendix 5, wherein the reflection portion is provided at a metal layer of a base plate, the metal layer overlapping with a wiring layer formed in a periphery of the opening portion in plan view.

With the configuration in Appendix 6, the first light incident on the opening portion is not blocked by the metal layer, and the utilization efficiency of the first light can be improved can be improved.

### Appendix 7

A projector according to any one of Appendix 1 to Appendix 6, wherein a focal length of the first collimating element is more than a length from the first incidence end to the first emission end, a focal length of the second collimating element is more than a length from the second incidence end to the second emission end, and a focal length of the third collimating element is more than a length from the third incidence end to the third emission end.

With the configuration in Appendix 7, the number of components can be reduced, an increase in size of the three-panel projector can be prevented, and a small projector can be achieved.

### Appendix 8

A projector according to any one of Appendix 1 to Appendix 7, wherein the first light source includes a light emitter and a phosphor configured to emit the first light as fluorescence by excitation light emitted from the light emitter.

With the configuration in Appendix 8, the first light reflected at the reflection portion of the first optical modulating element is incident on the phosphor of the first light source, and the phosphor is re-excited. With this, the utilization efficiency of the first light can be improved.

### Appendix 9

A projector according to any one of Appendix 1 to Appendix 8, wherein a cross-sectional shape of the first light guide element is a rectangular shape, a cross-sectional shape of the second light guide element is a rectangular shape, and a cross-sectional shape of the third light guide element is a rectangular shape.

With the configuration in Appendix 9, the color light according to the rectangular modulating surface of each of the first optical modulating element, the second optical modulating element, and the third optical modulating element can be generated easily.

### Appendix 10

A projector according to any one of Appendix 1 to Appendix 9, including a first polarizing element being arranged between the first collimating element and the first optical modulating element and being configured to transmit a part containing a first polarized light component in the first light and reflect the other part, a second polarizing element being arranged between the second collimating element and the second optical modulating element and being configured to transmit a part containing a second polarized light component in the second light and reflect the other part, and a third polarizing element being arranged between the third collimating element and the third optical modulating element and being configured to transmit a part containing a third polarized light component in the third light and reflect the other part, wherein the other part of the first light is incident on the first light guide element, the other part of the second light is incident on the second light guide element, and the other part of the third light is incident on the third light guide element.

With the configuration in Appendix 10, the first light, the second light, and the third light that are reflected at the first polarizing element, the second polarizing element, and the third polarizing element can be incident again on the first light guide element, the second light guide element, and the third light guide element. Thus, the utilization efficiency of the first light, the second light, and the third light can be improved.

### Appendix 11

A projector according to any one of Appendix 1 to Appendix 10, wherein a cross-sectional are of the first emission end is larger than a cross sectional area of the first incidence end, a cross-sectional are of the second emission end is larger than a cross sectional area of the second incidence end, and a cross-sectional are of the third emission end is larger than a cross sectional area of the third incidence end.

With the configuration in Appendix 11, the sizes of the irradiation regions with the first light, the second light, and the third light emitted from the first light source, the second light source, and the third light source can match with the sizes of the modulating surfaces of the first optical modulating element, the second optical modulating element, and the third optical modulating element, and the illumination intensity distribution of the first light, the second light, and the third light can be equalized and expanded.

### Appendix 12

A projector according to any one of Appendix 1 to Appendix 12, wherein the first light guide element, the second light guide element, and the third light guide element are formed of glass or metal.

With the configuration in Appendix 12, heat radiation and heat resistance of the first light guide element, the second light guide element, and the third light guide element can be improved.

### Appendix 13

A projector according to any one of Appendix 1 to Appendix 13, wherein the first light guide element, the second light guide element, and the third light guide element are hollow, and a reflection film is provided to inner surfaces of the first light guide element, the second light guide element, and the third light guide element.

With the configuration in Appendix 13, the losses of the first light, the second light, and the third light that are caused in the first light guide element, the second light guide element, and the third light guide element can be suppressed, and the utilization efficiency of the first light, the second light, and the third light can be improved.

### Appendix 14

A projector according to any one of Appendix 1 to Appendix 14, wherein a cross-sectional shape of the first light guide element is a rectangular shape, a cross-sectional shape of the second light guide element is a rectangular shape, a cross-sectional shape of the third light guide element is a rectangular shape, 7 degrees≤α≤22 degrees, wherein α is a gradient angle of a side surface including short sides of the first light guide element, the second light guide element, and the third light guide element, 14 degrees≤β≤36 degrees, wherein β is a gradient angle of a side surface including long sides of the first light guide element, the second light guide element, and the third light guide element, a reflection film is provided to inner surfaces of the first light guide element, the second light guide element, and the third light guide element, and 60 degrees≤θᵢₙ≤90 degrees, wherein θᵢₙ is an incident angle of light incident on the reflection film when a reflectance at the reflection film is the highest.

With the configuration in Appendix 14, the loses of the first light, the second light, and the third light that are reflected within the first light guide element, the second light guide element, and the third light guide element and are emitted from the first emission end, the second emission end, and the third emission end can be suppressed, and the utilization efficiency of the first light, the second light, and the third light can be improved.

### Appendix 15

A projector including a fourth polarizing element being arranged between the first optical modulating element and the photosynthetic element and being configured to transmit a part containing a fourth polarized light component in the light emitted from the first optical modulating element and absorb the other part, a fifth polarizing element being arranged between the second optical modulating element and the photosynthetic element and being configured to transmit a part containing a fifth polarized light component in the light emitted from the second optical modulating element and absorb the other part, and a sixth polarizing element being arranged between the third optical modulating element and the photosynthetic element and being configured to transmit a part containing a sixth polarized light component in the light emitted from the third optical modulating element and absorb the other part.

With the configuration in Appendix 15, the parts containing the fourth polarized light component, the fifth polarized light component, and the sixth polarized light component in the light emitted from the first optical modulating element, the second optical modulating element, and the third optical modulating element are incident on the photosynthetic element, and the fourth polarizing element, the fifth polarizing element, and the sixth polarizing element absorb the other parts other than the fourth polarized light component, the fifth polarized light component, and the sixth polarized light component in the light emitted from the first optical modulating element, the second optical modulating element, and the third optical modulating element. With this, the other parts other than the fourth polarized light component, the fifth polarized light component, and the sixth polarized light component can be prevented from returning to the first optical modulating element, the second optical modulating element, and the third optical modulating element or becoming stray light.

What is claimed is:

1. A projector comprising:
a first light source configured to emit a first light in a first wavelength band;
a second light source configured to emit a second light in a second wavelength band different from the first wavelength band;
a third light source configured to emit a third light in a third wavelength band different from the first wavelength band and the second wavelength band;
a first light guide element including a first incidence end on which the first light emitted from the first light source is incident and a first emission end from which the first light is emitted, and being configured to equalize an in-plane illumination intensity of the first light;
a second light guide element including a second incidence end on which the second light emitted from the second light source is incident and a second emission end from which the second light is emitted, and being configured to equalize an in-plane illumination intensity of the second light;
a third light guide element including a third incidence end on which the third light emitted from the third light source is incident and a third emission end from which the third light is emitted, and being configured to equalize an in-plane illumination intensity of the third light;
a first collimating element configured to collimate the first light emitted from the first light guide element;
a second collimating element configured to collimate the second light emitted from the second light guide element;
a third collimating element configured to collimate the third light emitted from the third light guide element;
a first optical modulating element configured to modulate the first light emitted from the first collimating element, based on image information;
a second optical modulating element configured to modulate the second light emitted from the second collimating element, based on image information;
a third optical modulating element configured to modulate the third light emitted from the third collimating element, based on image information;
a photosynthetic element configured to synthesize and emit the first light emitted from the first optical modulating element, the second light emitted from the second optical modulating element, and the third light emitted from the third optical modulating element; and
a projection optical system configured to project the light emitted from the photosynthetic element, wherein
the first optical modulating element is provided with a reflection portion on a first surface side on which the first light is incident and in a region other than an opening portion of a display region.

2. A projector comprising:
a first light source configured to emit a first light in a first wavelength band;
a second light source configured to emit a second light in a second wavelength band different from the first wavelength band;
a third light source configured to emit a third light in a third wavelength band different from the first wavelength band and the second wavelength band;
a first light guide element including a first incidence end on which the first light emitted from the first light source is incident and a first emission end from which the first light is emitted, and being configured to equalize an in-plane illumination intensity of the first light;
a second light guide element including a second incidence end on which the second light emitted from the second light source is incident and a second emission end from which the second light is emitted, and being configured to equalize an in-plane illumination intensity of the second light;
a third light guide element including a third incidence end on which the third light emitted from the third light source is incident and a third emission end from which the third light is emitted, and being configured to equalize an in-plane illumination intensity of the third light;
a first collimating element configured to collimate the first light emitted from the first light guide element;
a second collimating element configured to collimate the second light emitted from the second light guide element;
a third collimating element configured to collimate the third light emitted from the third light guide element;
a first optical modulating element configured to modulate the first light emitted from the first collimating element, based on image information;
a second optical modulating element configured to modulate the second light emitted from the second collimating element, based on image information;
a third optical modulating element configured to modulate the third light emitted from the third collimating element, based on image information;
a photosynthetic element configured to synthesize and emit the first light emitted from the first optical modulating element, the second light emitted from the second optical modulating element, and the third light emitted from the third optical modulating element; and
a projection optical system configured to project the light emitted from the photosynthetic element, wherein
the first optical modulating element includes a reflection portion on a first surface side on which the first light is incident and an outer side of a display region.

3. A projector according to claim 1, wherein
the reflection portion is provided between the display region and a light incidence region on which the first light is incident, and
a light shielding portion is provided between an outer side of the light incidence region to an end portion of the first optical modulating element.

4. A projector according to claim 1, wherein
the reflection portion is provided to a partition portion of a base plate on the first surface side of the first optical modulating element.

5. A projector according to claim 1, wherein
the reflection portion is provided to a fixing member of the first optical modulating element.

6. A projector according to claim 1, wherein
the reflection portion is provided at a metal layer of a base plate, the metal layer overlapping with a wiring layer formed in a periphery of the opening portion of the display region in plan view.

7. A projector according to claim 1, wherein
a focal length of the first collimating element is more than a length from the first incidence end to the first emission end,
a focal length of the second collimating element is more than a length from the second incidence end to the second emission end, and
a focal length of the third collimating element is more than a length from the third incidence end to the third emission end.

8. A projector according to claim 1, wherein
the first light source includes:
a light emitter; and
a phosphor configured to emit the first light as fluorescence by excitation light emitted from the light emitter.

9. A projector according to claim 1, wherein
a cross-sectional shape of the first light guide element is a rectangular shape,
a cross-sectional shape of the second light guide element is a rectangular shape, and
a cross-sectional shape of the third light guide element is a rectangular shape.

10. A projector according to claim 1, comprising:
a first polarizing element being arranged between the first collimating element and the first optical modulating element and being configured to transmit a part containing a first polarized light component in the first light and reflect an other part of the first light,
a second polarizing element being arranged between the second collimating element and the second optical modulating element and being configured to transmit a part containing a second polarized light component in the second light and reflect an other part of the second light, and
a third polarizing element being arranged between the third collimating element and the third optical modulating element and being configured to transmit a part containing a third polarized light component in the third light and reflect an other part of the third light, wherein
the other part of the first light is incident on the first light guide element,
the other part of the second light is incident on the second light guide element, and
the other part of the third light is incident on the third light guide element.

11. A projector according to claim 1, wherein
a cross-sectional are of the first emission end is larger than a cross sectional area of the first incidence end,
a cross-sectional are of the second emission end is larger than a cross sectional area of the second incidence end, and
a cross-sectional are of the third emission end is larger than a cross sectional area of the third incidence end.

12. A projector according to claim 1, wherein
the first light guide element, the second light guide element, and the third light guide element are formed of glass or metal.

13. A projector according to claim 1, wherein
the first light guide element, the second light guide element, and the third light guide element are hollow, and
a reflection film is provided to inner surfaces of the first light guide element, the second light guide element, and the third light guide element.

14. A projector according to claim 1, wherein
a cross-sectional shape of the first light guide element is a rectangular shape,
a cross-sectional shape of the second light guide element is a rectangular shape,
a cross-sectional shape of the third light guide element is a rectangular shape,
7 degrees≤α≤22 degrees, wherein α is a gradient angle of a side surface including short sides of the first light guide element, the second light guide element, and the third light guide element,
14 degrees≤β≤36 degrees, wherein β is a gradient angle of a side surface including long sides of the first light guide element, the second light guide element, and the third light guide element,
a reflection film is provided to inner surfaces of the first light guide element, the second light guide element, and the third light guide element, and
60 degrees≤θᵢₙ≤90 degrees, wherein θᵢₙ is an incident angle of light incident on the reflection film when a reflectance at the reflection film is the highest.

15. A projector according to claim 1, comprising:
a fourth polarizing element being arranged between the first optical modulating element and the photosynthetic element and being configured to transmit a part containing a fourth polarized light component in the first light emitted from the first optical modulating element and absorb an other part of the first light emitted from the first optical modulating element;
a fifth polarizing element being arranged between the second optical modulating element and the photosynthetic element and being configured to transmit a part containing a fifth polarized light component in the second light emitted from the second optical modulating element and absorb an other part of the second light emitted from the second optical modulating element; and
a sixth polarizing element being arranged between the third optical modulating element and the photosynthetic element and being configured to transmit a part containing a sixth polarized light component in the third light emitted from the third optical modulating element and absorb an other part of the third light emitted from the third optical modulating element.
